(19) United States
(12) Patent Application Publication
(10) Pub. No.: US 2026/0349362 A1
(43) Pub. Date: Nov. 5, 2026

(54) TONER FOR STATIC CHARGE IMAGE DEVELOPMENT AND METHOD FOR MANUFACTURING SAME

(71) Applicant: KAO CORPORATION, Tokyo (JP)

(72) Inventors: Taiki YAMAMOTO, Wakayama-shi (JP); Hiroto HAYASHI, Wakayama-shi (JP); George HIRAI, Wakayama-shi (JP); Yuji MARUNO, Wakayama-shi (JP); Shoichi MURATA, Wakayama-shi (JP)

(73) Assignee: KAO CORPORATION, Tokyo (JP)

(21) Appl. No.: 19/137,200

(22) PCT Filed: Dec. 12, 2023
(86) PCT No.: PCT/JP2023/044449

§ 371 Date: Jun. 9, 2025

(30) Foreign Application Priority Data
Dec. 12, 2022 (JP) 2022-198126

(51) Int. Cl. G03G 9/087; G03G 9/08; G03G 9/09

(52) U.S. Cl. CPC G03G 9/08755; G03G 9/0804; G03G 9/0906; G03G 9/091

(57) ABSTRACT

An electrostatic image development toner containing a crystalline polyester resin C, an amorphous polyester-based resin A, and a colorant, in which the crystalline polyester resin C includes a structural unit derived from an aliphatic diol component containing ethylene glycol and a structural unit derived from an aliphatic dicarboxylic acid component having 10 to 14 carbon atoms, and has an ester group concentration of 6.5 mmol/g to 9.0 mmol/g, and the colorant is a pigment having a NH group amount of 6.0 mmol/g or more, the NH group amount being obtained by dividing a total number of —NH— and —NH₂ groups contained in one molecule of the pigment by a molecular weight of the pigment.

### TECHNICAL FIELD

The present invention relates to an electrostatic image development toner used in developing a latent image formed in an electrophotographic method, an electrostatic recording method, an electrostatic printing method or the like, and a method for producing the same.

### BACKGROUND ART

With the diversification of print media, there is an increasing demand for electrophotographic printing on print media other than paper. As main media, there are plastic films such as polyethylene terephthalate film, polypropylene film, and polyethylene film, which are used for PET bottle labels and various packages. Since these plastic films have a smooth surface, an anchoring effect hardly occurs between the surface and a coating film (printed coating film) formed by printing an electrophotographic toner on the surface, and consequently the printed coating film is easily peeled off from the plastic film. In addition, these plastic films are vulnerable to heat, causing the printing media to curl and shrink when the electrophotographic toner is thermally fused.

Patent Document 1 (JP 2022-54448 A) discloses a method for forming an image on a polypropylene film or polyethylene film, the method being a method for forming an image on a polypropylene film or polyethylene film using a toner containing a crystalline polyester resin C in a binder resin for the purpose of providing an image forming method which provides an image having an excellent image density and an excellent abrasion resistance, in which the crystalline polyester resin C has an SP value of 9.0 or more and 10.1 or less, the content of the crystalline polyester resin C in the binder resin is 10 mass % or more and 60 mass % or less, the surface tension of a printed surface of the polypropylene film or polyethylene film is 35 mN/m or more and 49 mN/m or less, and the fusing temperature is a temperature which is at most 5 °C higher than the melting point of the polypropylene film or polyethylene film.

Patent Document 2 (JP 2020-60687 A) discloses an electrostatic image development toner containing an amorphous polyester resin and a crystalline polyester resin, in which the amorphous polyester resin is a polycondensate of an alcohol component (A-al) and a carboxylic acid component (A-ac) containing a succinic acid substituted with a linear aliphatic hydrocarbon group having 16 or more and 18 or less carbon atoms or an anhydride thereof, the crystalline polyester resin is a polycondensate of an alcohol component (C-al) and a carboxylic acid component (C-ac), and the electrostatic image development toner contains a monoalcohol having 6 or more and 24 or less carbon atoms as the alcohol component (C-al) and at least one selected from the group consisting of monocarboxylic acids having 6 or more and 24 or less carbon atoms as the carboxylic acid component (C-ac), and also discloses that the electrostatic image development toner is excellent in terms of low-temperature fusing property and heat-resistant storage stability of the toner, and also excellent in terms of storage stability of printed matter.

### SUMMARY OF INVENTION

The present invention relates to the following [1] and [2].

[1] An electrostatic image development toner containing a crystalline polyester resin C, an amorphous polyester-based resin A, and a colorant, in which
the crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and
the colorant is a pigment having a NH group amount of 6.0 mmol/g or more, the NH group amount being obtained by dividing a total number of —NH— and —NH₂ contained in one molecule of the pigment by a molecular weight of the pigment.

[2]A method for producing an electrostatic image development toner, including: a step of aggregating resin particles containing a crystalline polyester resin C and an amorphous polyester-based resin A in the same or different particles and a colorant in an aqueous medium; and a step of coalescing the resin particles and the colorant, in which
the crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and
the colorant is a pigment having a NH group amount of 6.0 mmol/g or more, the NH group amount being obtained by dividing a total number of —NH— and —NH₂ contained in one molecule of the pigment by a molecular weight of the pigment.

### DESCRIPTION OF EMBODIMENTS

Packaging printed matter such as a PET bottle label or a package film is required to have a printed coating film having high fastness, from the viewpoints of quality protection of contents and information display. A printed coating film formed using a printing ink for packaging printed matter is evaluated for coating film hardness by a pencil hardness test, and is required to have a hardness of B or higher in terms of pencil hardness. As a result of investigation by the present inventors, it has been found that the packaging printed matter obtained by forming a printed coating film on a printing medium such as a plastic film using the image forming method described in Patent Document 1 and the electrostatic image development toner described in Patent Document 2, has good fastness of the printed coating film in a tape peeling test and a nail rubbing test, but that its fastness in the pencil hardness test needs to be improved. In addition, the toner is required to have low-temperature fusing property in order to suppress thermal shrinkage of a printing medium such as a plastic film.

The present invention relates to an electrostatic image development toner excellent in low-temperature fusing property and capable of forming a printed coating film having high fastness on a printing medium (substrate) such as a plastic film, and a method for producing the same.

The present inventors have found that an electrostatic image development toner containing a crystalline polyester resin C, an amorphous polyester-based resin A, and a colorant, in which the crystalline polyester resin C includes a structural unit derived from an aliphatic diol component containing ethylene glycol and a structural unit derived from an aliphatic dicarboxylic acid component having 10 or more and 14 or less carbon atoms and has an ester group concentration in a specific range, and the colorant is a pigment having a NH group amount controlled to a specific value or more, has excellent low-temperature fusing property, and that the toner can be used to form a printed coating film having high fastness.

According to the present invention, there are provided an electrostatic image development toner excellent in low-temperature fusing property and capable of forming a printed coating film having high fastness on a printing medium (substrate) such as a plastic film, and a method for producing the same.

### [Electrostatic Image Development Toner]

The electrostatic image development toner of the present invention (hereinafter, also simply referred to as “toner”) contains at least a crystalline polyester resin C (hereinafter, also simply referred to as “resin C”), an amorphous polyester-based resin A (hereinafter, also simply referred to as “resin A”), and a colorant.

The crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and the colorant is a pigment having a NH group amount of 6.0 mmol/g or more, the NH group amount being obtained by dividing the total number of —NH— and —NH₂ contained in one molecule of the pigment by a molecular weight of the pigment.

Due to the above-described characteristics, the toner of the present invention has excellent low-temperature fusing property, and the toner can be used to form a printed coating film having high fastness.

Toner particles containing at least the resin C, the resin A, and the colorant (hereinafter, also simply referred to as “toner particles”) can be used as the toner of the present invention as they are, but it is preferable to use toner particles that have been treated by adding a fluidizing agent or the like as an external additive to the toner particle surface.

The reason why the toner of the present invention is excellent in low-temperature fusing property and can be used to form a printed coating film having high fastness is not clear, but is considered as follows.

The toner of the present invention contains the crystalline polyester resin C including a structural unit derived from an aliphatic diol component containing ethylene glycol, and thus can have arranged therein two ester groups close to each other, which results in high cohesive force and possible rapid generation of crystal nuclei. Therefore, the crystal domains become finely dispersed in the toner particles without enlargement while toner particles are formed. In addition, it is considered that an increase in polarity due to the close ester groups, at the time of fusing process, improves compatibility with the amorphous polyester-based resin A and rapidly advances melting of the toner, and thus that the low-temperature fusing property is excellent.

In addition, as a result of investigation by the present inventors, it has been found that the hardness of the printed coating film itself is important for improving the fastness in the pencil hardness test of the printed coating film formed on a substrate such as a plastic film. This is considered to be because a strong force is locally applied when the coating film is scraped with a pencil having a sharp tip. In the toner of the present invention, the crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and thus the compatibility with the amorphous polyester resin A is improved while securing the cohesive force of the crystalline polyester resin C after coating film formation, and a state in which crystal domains of the crystalline polyester resin C are finely dispersed in a printed coating film is formed. Furthermore, due to the NH group amount of the pigment as the colorant being 6.0 mmol/g or more, the ester group in the crystalline polyester resin C and the NH group contained in the pigment effectively interact with each other, thereby promoting recrystallization of the crystalline polyester resin C after coating film formation. This is considered to result in a significant improvement in the cohesive force of the crystalline polyester resin C in the printed coating film and an increase in the hardness of the printed coating film, whereby fastness is improved.

Definitions and the like of various terms in the present specification will be shown below.

In the specification, the carboxylic acid component of the polyester-based resin includes not only a compound thereof but also an anhydride which is decomposed during a reaction to generate a carboxylic acid and an alkyl ester (an alkyl group having 1 or more 3 or less carbon atoms) of each carboxylic acid.

Whether a resin is crystalline or amorphous is determined by its crystallinity index. The crystallinity index is defined by a ratio of a softening point of the resin to a maximum endothermic peak temperature (softening point (°C)/maximum endothermic peak temperature (°C)) in a measurement method described in Examples below. The crystalline resin has a crystallinity index of 0.6 or more and 1.4 or less. The amorphous resin is a resin having no endothermic peak observed, or having a crystallinity index of less than 0.6 or more than 1.4 when an endothermic peak is observed. The crystallinity index can be appropriately adjusted by adjusting the types and ratio of raw material monomers, and production conditions such as reaction temperature, reaction time, and cooling rate.

With respect to a hydrocarbon group, the parenthetical descriptions “(iso or tertiary)” and “(iso)” mean both the case where these prefixes are present and the case where these prefixes are not present. In a case where these prefixes are not present, the hydrocarbon group is normal.

The expression “(meth)acrylic acid” means at least one selected from acrylic acid and methacrylic acid.

The expression “styrene-based compound” means unsubstituted or substituted styrene.

### [Toner Particles]

In the present invention, the toner particles contain at least a crystalline polyester resin C (hereinafter, also simply referred to as “resin C”), an amorphous polyester-based resin A (hereinafter, also simply referred to as “resin A”), and a colorant.

### <Crystalline Polyester Resin C>

The resin C is used as a binder resin of the toner. From the viewpoints of the low-temperature fusing property of the toner and the fastness of the printed coating film, the resin C is a polycondensate including a structural unit derived from an aliphatic diol component containing ethylene glycol as a structural unit derived from an alcohol component and a structural unit derived from an aliphatic dicarboxylic acid component having 10 or more and 14 or less carbon atoms as a structural unit derived from a carboxylic acid component, and has an ester group concentration of from 6.5 mmol/g or more and 9.0 mmol/g or less. Each of the alcohol component and carboxylic acid component below can be used alone, or two or more thereof can be used in combination.

The aliphatic diol component contains ethylene glycol and may contain an aliphatic diol other than ethylene glycol.

Examples of the aliphatic diol other than ethylene glycol include 1,2-propanediol, 1,3-propanediol, 1,2-butanediol, 1,3-butanediol, 1,4-butanediol, 2,3-butanediol, 2-butene-1,4-diol, 1,5-pentanediol, 1,6-hexanediol, 1,7-heptanediol, 1,8-octanediol, neopentyl glycol, 1,9-nonanediol, 1,10-decanediol, 1,11-undecanediol, and 1,12-dodecanediol.

The amount of the aliphatic diol component in the alcohol component is preferably 80 mol % or more, more preferably 85 mol % or more, even more preferably 90 mol % or more, and still even more preferably 95 mol % or more, and is 100 mol % or less, and more preferably 100 mol %.

The amount of the aliphatic diol component in the alcohol component is the same as a content of the structural unit derived from the aliphatic diol component in the structural unit derived from the alcohol component. The same applies to the following description of the amount of each component of the resin.

The amount of ethylene glycol in the aliphatic diol component is preferably 80 mol % or more, more preferably 85 mol % or more, even more preferably 90 mol % or more, and still even more preferably 95 mol % or more, and is 100 mol % or less, and preferably 100 mol %.

The amount of ethylene glycol in the alcohol component is preferably 65 mol % or more, more preferably 85 mol % or more, even more preferably 90 mol % or more, and still even more preferably 95 mol % or more, and is 100 mol % or less, and preferably 100 mol %.

The alcohol component may contain another alcohol component different from the aliphatic diol component. Examples of the other alcohol component include alkylene oxide adducts of aromatic diols such as alkylene oxide adducts of bisphenol A; and trihydric or higher hydric alcohols such as glycerin, pentaerythritol, and trimethylolpropane.

The number of carbon atoms of the aliphatic dicarboxylic acid is 14 or less from the viewpoints of the low-temperature fusing property of the toner and the fastness of the printed coating film, and is 10 or more and preferably 12 or more from the same viewpoints. The aliphatic dicarboxylic acid is preferably an α,ω-linear aliphatic dicarboxylic acid.

Specific examples of the aliphatic dicarboxylic acid having 10 or more and 14 or less carbon atoms include preferably one or more selected from sebacic acid, 1,11-undecanedioic acid, 1,12-dodecanedioic acid, 1,13-tridecanedioic acid and 1,14-tetradecanedioic acid, more preferably one or more selected from sebacic acid, 1,12-dodecanedioic acid and 1,14-tetradecanedioic acid, and even more preferably one or more selected from 1,12-dodecanedioic acid and 1,14-tetradecanedioic acid, from the viewpoints of the low-temperature fusing property of the toner and the fastness of the printed coating film.

The amount of the aliphatic dicarboxylic acid having 10 or more and 14 or less carbon atoms in the carboxylic acid component is preferably 70 mol % or more, more preferably 75 mol % or more, even more preferably 80 mol % or more, and still even more preferably 85 mol % or more, and is 100 mol % or less, and preferably 95 mol % or less.

The carboxylic acid component preferably contains a monocarboxylic acid component having 6 or more and 24 or less carbon atoms from the viewpoints of the low-temperature fusing property of the toner and the fastness of the printed coating film. From the same viewpoints, the number of carbon atoms of the monocarboxylic acid component is 6 or more, preferably 8 or more, more preferably 12 or more, even more preferably 14 or more, and still even more preferably 16 or more, and is 24 or less, preferably 22 or less, and more preferably 20 or less.

Examples of the monocarboxylic acid having 6 or more and 24 or less carbon atoms include caprylic acid, pelargonic acid, lauric acid, myristic acid, palmitic acid, stearic acid, arachidic acid, behenic acid, and lignoceric acid. Among these, caprylic acid, lauric acid, stearic acid, and behenic acid are preferred, and, from the viewpoint of obtaining a printed coating film having high low-temperature fusing property and fastness, stearic acid and behenic acid are more preferred, and stearic acid is even more preferred.

The amount of the monocarboxylic acid having 6 or more and 24 or less carbon atoms in the carboxylic acid component is preferably 1 mol % or more, more preferably 5 mol % or more, and even more preferably 7 mol % or more, and is preferably 35 mol % or less, more preferably 30 mol % or less, even more preferably 20 mol % or less, and still even more preferably 15 mol % or less.

The carboxylic acid component may contain another carboxylic acid component different from the aliphatic dicarboxylic acid having 10 or more and 14 or less carbon atoms and the monocarboxylic acid having 6 or more and 24 or less carbon atoms. Examples of the other carboxylic acid component include aromatic dicarboxylic acids such as terephthalic acid and isophthalic acid; and trivalent or higher valent polycarboxylic acids such as trimellitic acid.

The equivalent ratio [COOH group/OH group] of the carboxyl group of the carboxylic acid component to the hydroxyl group of the alcohol component is preferably 0.7 or more, and more preferably 0.8 or more, and is preferably 1.3 or less, and more preferably 1.2 or less.

The ester group concentration of the resin C is 6.5 mmol/g or more and 9.0 mmol/g or less, and preferably 6.7 mmol/g or more, and is preferably 8.8 mmol/g or less, and more preferably 8.6 mmol/g or less, from the viewpoints of the low-temperature fusing property of the toner and the fastness of the printed coating film. The ester group concentration of the resin C is calculated by the following equation.

$$[ ESTER GROUP CONCENTRATION ( mmol / g ) ] = \frac{[ A ( mol ) ]}{[ B ( g ) - A ( mol ) \times 18 ]} \times {10}^{3} \qquad [ Math 1 ]$$

where A denotes the total amount (mol) of ester bonds generated when all of the raw material monomers for the crystalline polyester resin C are reacted, and B denotes the total mass (g) of the raw material monomers constituting the crystalline polyester resin C. In the equation, the unit of each numerical value is shown in parentheses.

When two or more resins are mixed and used as the crystalline polyester resin C, a weighted average of the ester group concentration of the crystalline polyester resin C is defined as the ester group concentration of the crystalline polyester resin C. In addition, when the crystalline polyester resin C is a composite resin, B denotes the total mass (g) of raw material monomers for a constituent portion derived from a polyester resin (polyester resin segment).

### (Method for Producing Crystalline Polyester Resin C)

The resin C can be produced by, for example, polycondensing raw material monomers including an alcohol component and a carboxylic acid component.

The polycondensation of the alcohol component and the carboxylic acid component can be performed, for example, in an inert gas atmosphere, optionally in the presence of an esterification catalyst, an esterification co-catalyst, a polymerization inhibitor, or the like, at a temperature of about 120 °C or higher and 250 °C or lower.

Examples of the esterification catalyst include tin compounds such as dibutyltin oxide and tin (II) di(2-ethylhexanoate), and titanium compounds such as titanium diisopropoxybis(triethanolaminate). Examples of the esterification co-catalyst that can be used together with the esterification catalyst include gallic acid (3,4,5-trihydroxybenzoic acid).

The amount of the esterification catalyst to be used is preferably 0.01 parts by mass or more and 10 parts by mass or less relative to 100 parts by mass of the total amount of the alcohol component and the carboxylic acid component which are the raw material monomers for the resin C.

The amount of the esterification co-catalyst to be used is preferably 0.001 parts by mass or more and 1 part by mass or less relative to 100 parts by mass of the total amount of the alcohol component and the carboxylic acid component.

Examples of the polymerization inhibitor include radical polymerization inhibitors such as 4-tert-butylcatechol.

When a polymerization inhibitor is used, the amount of the polymerization inhibitor to be used is preferably 0.01 parts by mass or more and 1 part by mass or less relative to 100 parts by mass of the total amount of the alcohol component and the carboxylic acid component.

### (Physical Properties of Crystalline Polyester Resin C)

The softening point of the resin C is preferably 60 °C or higher, more preferably 65 °C or higher, and even more preferably 70 °C or higher, and, from the viewpoint of further improving the low-temperature fusing property, is preferably 150 °C or lower, more preferably 120 °C or lower, and even more preferably 100 °C or lower.

The melting point of the resin C is preferably 50 °C or higher, more preferably 60 °C or higher, and even more preferably 70 °C or higher, and, from the viewpoint of further improving the low-temperature fusing property, is preferably 100 °C or lower, more preferably 95 °C or lower, and even more preferably 90 °C or lower.

The acid value of the resin C is preferably 2 mgKOH/g or more, and more preferably 4 mgKOH/g or more, and is preferably 20 mgKOH/g or less, more preferably 15 mgKOH/g or less, and even more preferably 10 mgKOH/g or less.

The solubility parameter (SP_{C}) of the resin C is preferably 8.70 (cal/cm³)^{1/2} or more, more preferably 9.00 (cal/cm³)^{1/2} or more, and even more preferably 9.50 (cal/cm³)^{1/2} or more, and is preferably 11.00 (cal/cm³)^{1/2} or less, more preferably 10.50 (cal/cm³)^{1/2} or less, and even more preferably 10.20 (cal/cm³)^{1/2} or less. The SP_{C} is a value calculated by the Fedors method.

The ester group concentration, softening point, melting point, acid value, and solubility parameter of the resin C can be appropriately adjusted by the types of the raw material monomers and amounts thereof to be used, and the production conditions such as the reaction temperature, the reaction time, and the cooling rate. The softening point, melting point, and acid value are determined by the methods described in Examples below. When two or more resins C are used in combination, the ester group concentration, softening point, melting point, acid value, and solubility parameter value of the obtained mixture thereof preferably fall within the ranges described above.

The mass ratio [resin A/resin C] of the content of the amorphous polyester-based resin (resin A) described below to the content of the resin C in the toner particles is preferably 55/45 or more, more preferably 60/40 or more, and even more preferably 65/35 or more, and is also preferably 90/10 or less, more preferably 85/15 or less, and even more preferably 78/22 or less, from the viewpoints of the low-temperature fusing property of the toner and the fastness of the printed coating film.

The content of the crystalline polyester resin C in the toner particles is preferably 5 mass % or more, more preferably 10 mass % or more, and even more preferably 15 mass % or more, and is preferably 40 mass % or less, more preferably 35 mass % or less, and even more preferably 30 mass % or less.

### <Amorphous Polyester-Based Resin A>

The toner of the present invention contains an amorphous polyester-based resin A. The resin A is used as a binder resin of the toner and is, for example, an amorphous polyester-based resin containing a polycondensate of an alcohol component and a carboxylic acid component.

Examples of the resin A include polyester resins and modified polyester-based resins. Examples of the modified polyester-based resin include a urethane-modified polyester resin, an epoxy-modified polyester resin, and a composite resin containing a polyester resin segment and an addition polymerization resin segment. Among them, the resin A is preferably a polyester resin or a composite resin, and more preferably a composite resin.

Examples of the alcohol component of the resin A include an alkylene oxide adduct of an aromatic diol, a linear or branched aliphatic diol, an alicyclic diol, and a trihydric or higher polyhydric alcohol. Among these, an alkylene oxide adduct of an aromatic diol and a linear or branched aliphatic diol are preferred from the viewpoint of obtaining a toner having excellent low-temperature fusing property, and an alkylene oxide adduct of an aromatic diol is more preferred from the viewpoint of the fastness of the printed coating film.

The alkylene oxide adduct of an aromatic diol is preferably an alkylene oxide adduct of bisphenol A, and more preferably an alkylene oxide adduct of 2,2-bis(4-hydroxyphenyl)propane represented by Formula (I):

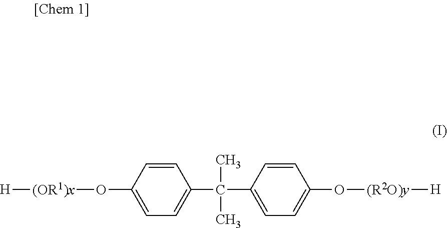

where OR¹ and R²O denote oxyalkylene groups, R¹ and R² each independently denote an ethylene group or a propylene group, x and y represent average numbers of moles of alkylene oxide added and are each a positive number, and a sum value of x and y is 1 or more, and preferably 1.5 or more, and is 16 or less, preferably 8 or less, and more preferably 4 or less.

Examples of the alkylene oxide adduct of bisphenol A represented by Formula (I) include a propylene oxide adduct of bisphenol A and an ethylene oxide adduct of bisphenol A. Among them, at least a propylene oxide adduct of bisphenol A is preferably contained.

When an alkylene oxide adduct of bisphenol A is contained, the amount thereof in the alcohol component is preferably 80 mol % or more, and more preferably 90 mol % or more, and is 100 mol % or less, and more preferably 100 mol %.

Examples of the linear or branched aliphatic diol include ethylene glycol, 1,2-propanediol, 1,3-propanediol, 1,2-butanediol, 1,3-butanediol, 1,4-butanediol, 2,3-butanediol, neopentyl glycol (2,2-dimethyl-1,3-propanediol), 1,6-hexanediol, 1,8-octanediol, 1,9-nonanediol, 1,10-decanediol, and 1,12-dodecanediol.

When a linear or branched aliphatic diol is used as the alcohol component, the amount thereof in the alcohol component is preferably 80 mol % or more, and more preferably 90 mol % or more, and is 100 mol % or less, and more preferably 100 mol %.

The amount of the neopentyl glycol in the linear or branched aliphatic diol is preferably 65 mol % or more, more preferably 85 mol % or more, even more preferably 90 mol % or more, and still even more preferably 95 mol % or more, and is 100 mol % or less, and preferably 100 mol %.

Examples of the alicyclic diol include hydrogenated bisphenol A [2,2-bis(4-hydroxycyclohexyl)propane] and an adduct of hydrogenated bisphenol A with an alkylene oxide having 2 or more and 4 or less carbon atoms (average number of moles added: 2 or more and 12 or less).

Examples of the trihydric or higher polyhydric alcohol include glycerin, pentaerythritol, trimethylolpropane, and sorbitol.

These alcohol components may be used alone, or two or more thereof may be used in combination.

Examples of the carboxylic acid component of the resin A include a dicarboxylic acid and a trivalent or higher valent polycarboxylic acid.

Examples of the dicarboxylic acid include an aromatic dicarboxylic acid, a linear or branched aliphatic dicarboxylic acid, and an alicyclic dicarboxylic acid. Among them, at least one selected from aromatic dicarboxylic acids and linear or branched aliphatic dicarboxylic acids is preferred.

Examples of the aromatic dicarboxylic acid include phthalic acid, isophthalic acid, and terephthalic acid. Among them, isophthalic acid and terephthalic acid are preferred, and terephthalic acid is more preferred.

The amount of the aromatic dicarboxylic acid in the carboxylic acid component is preferably 20 mol % or more, more preferably 30 mol % or more, and even more preferably 40 mol % or more, and is 100 mol % or less, preferably 85 mol % or less, more preferably 80 mol % or less, and even more preferably 75 mol % or less.

The number of carbon atoms of the linear or branched aliphatic dicarboxylic acid is preferably 2 or more, and more preferably 3 or more, and is preferably 30 or less, and more preferably 20 or less.

Examples of the linear or branched aliphatic dicarboxylic acid include oxalic acid, malonic acid, maleic acid, fumaric acid, citraconic acid, itaconic acid, glutaconic acid, succinic acid, adipic acid, sebacic acid, dodecanedioic acid, azelaic acid, and succinic acid substituted with an aliphatic hydrocarbon group having 1 or more and 20 or less carbon atoms. Examples of the succinic acid substituted with an aliphatic hydrocarbon group having 1 or more and 20 or less carbon atoms include dodecylsuccinic acid, dodecenylsuccinic acid and an anhydride thereof, and octenylsuccinic acid. Among these, fumaric acid, sebacic acid, adipic acid, and succinic acid substituted with an aliphatic hydrocarbon group having 1 or more and 20 or less carbon atoms are preferred.

In a case where a linear or branched aliphatic dicarboxylic acid is contained, the amount thereof in the carboxylic acid component is preferably 5 mol % or more, more preferably 10 mol % or more, and even more preferably 15 mol % or more, and is preferably 50 mol % or less, more preferably 45 mol % or less, and even more preferably 40 mol % or less.

Examples of the alicyclic dicarboxylic acid include cyclohexanedicarboxylic acid.

The trivalent or higher valent polycarboxylic acid is preferably a trivalent carboxylic acid, and examples thereof include trimellitic acid and an anhydride thereof.

When a trivalent or higher valent polycarboxylic acid is contained, the amount of the trivalent or higher valent polycarboxylic acid in the carboxylic acid component is preferably 3 mol % or more, more preferably 6 mol % or more, and even more preferably 9 mol % or more, and is preferably 25 mol % or less, more preferably 20 mol % or less, and even more preferably 15 mol % or less.

These carboxylic acid components may be used alone, or two or more thereof may be used in combination.

The equivalent ratio [COOH group/OH group] of the carboxyl group of the carboxylic acid component to the hydroxyl group of the alcohol component is preferably 0.7 or more, and more preferably 0.8 or more, and is preferably 1.3 or less, and more preferably 1.2 or less.

When the resin A is a composite resin, examples of the addition polymerization resin segment include an addition polymerization product of a raw material monomer containing a styrene-based compound.

Examples of the styrene-based compound include unsubstituted or substituted styrene. Examples of the substituent with which styrene is substituted include an alkyl group having 1 or more and 5 or less carbon atoms, a halogen atom, an alkoxy group having 1 or more and 5 or less carbon atoms, and a sulfonic acid group and a salt thereof.

Examples of the styrene-based compound include styrene, methylstyrene, α-methylstyrene, β-methylstyrene, tert-butylstyrene, chlorostyrene, chloromethylstyrene, methoxystyrene, and styrenesulfonic acid and a salt thereof. Among these, styrene is preferred. The content of the styrene-based compound in the raw material monomers for the addition polymerization resin segment is preferably 50 mass % or more, more preferably 65 mass % or more, and even more preferably 75 mass % or more, and is 100 mass % or less, preferably 95 mass % or less, more preferably 90 mass % or less, and even more preferably 85 mass % or less.

Examples of the raw material monomer other than the styrene-based compound include (meth)acrylic acid esters such as alkyl (meth)acrylate, benzyl (meth)acrylate, and dimethylaminoethyl (meth)acrylate; olefins such as ethylene, propylene, and butadiene; halovinyls such as vinyl chloride; vinyl esters such as vinyl acetate and vinyl propionate; vinyl ethers such as methyl vinyl ether; vinylidene halides such as vinylidene chloride; and N-vinyl compounds such as N-vinylpyrrolidone. Among these, (meth)acrylic acid esters are preferred, and alkyl (meth)acrylates are more preferred.

The number of carbon atoms of the alkyl group in the alkyl (meth)acrylate is preferably 1 or more, more preferably 4 or more, and even more preferably 6 or more, and is preferably 24 or less, more preferably 22 or less, and even more preferably 20 or less.

Examples of the alkyl (meth)acrylate include methyl (meth)acrylate, ethyl (meth)acrylate, (iso)propyl (meth)acrylate, (iso or tertiary) butyl, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate, (iso)palmityl (meth)acrylate, (iso)stearyl (meth)acrylate, and (iso)behenyl (meth)acrylate. The alkyl (meth)acrylate is preferably 2-ethylhexyl (meth)acrylate or stearyl (meth)acrylate, more preferably stearyl (meth)acrylate, and even more preferably stearyl methacrylate.

When the addition polymerization resin segment includes a structural unit derived from a (meth)acrylic acid ester, the content of the (meth)acrylic acid ester in the raw material monomers for the addition polymerization resin segment is preferably 5 mass % or more, more preferably 10 mass % or more, and even more preferably 15 mass % or more, and is preferably 50 mass % or less, more preferably 35 mass % or less, and even more preferably 25 mass % or less.

The total amount of the styrene-based compound and the (meth)acrylic acid ester in the raw material monomers for the addition polymerization resin segment is preferably 80 mass % or more, more preferably 90 mass % or more, even more preferably 95 mass % or more, and still even more preferably 100 mass %.

The composite resin preferably has a structural unit derived from a bireactive monomer bonded to the polyester resin segment and the addition polymerization resin segment via a covalent bond.

The “structural unit derived from a bireactive monomer” refers to a unit formed by reaction of a functional group and an addition polymerizable group of the bireactive monomer.

Examples of the addition polymerizable group include a carbon-carbon unsaturated bond (ethylenically unsaturated bond).

Examples of the bireactive monomer include an addition polymerizable monomer having at least one functional group selected from a hydroxyl group, a carboxyl group, an epoxy group, a primary amino group, and a secondary amino group in the molecule. Among these, from the viewpoint of reactivity, an addition polymerizable monomer having at least one functional group selected from a hydroxyl group and a carboxyl group is preferred, and an addition polymerizable monomer having a carboxyl group is more preferred.

Examples of the addition polymerizable monomer having a carboxyl group include acrylic acid, methacrylic acid, fumaric acid, and maleic acid. Among these, acrylic acid and methacrylic acid are preferred, and acrylic acid is more preferred, from the viewpoint of reactivities in both the polycondensation reaction and the addition polymerization reaction.

When the bireactive monomer is an addition polymerizable monomer having a carboxy group, the amount of the structural unit derived from the bireactive monomer is preferably 1 part by mole or more, more preferably 5 parts by mole or more, and even more preferably 8 parts by mole or more, and is preferably 30 parts by mole or less, more preferably 25 parts by mole or less, and even more preferably 20 parts by mole or less, relative to 100 parts by mole of the alcohol component of the polyester resin segment of the composite resin.

The content of the polyester resin segment in the composite resin is preferably 40 mass % or more, more preferably 45 mass % or more, and even more preferably 55 mass % or more, and is preferably 95 mass % or less, more preferably 90 mass % or less, and even more preferably 85 mass % or less, based on the total amount of the polyester resin segment and the addition polymerization resin segment. The structural unit derived from the bireactive monomer is the polyester resin segment.

The content of the addition polymerization resin segment in the composite resin is preferably 5 mass % or more, more preferably 10 mass % or more, and even more preferably 15 mass % or more, and is preferably 60 mass % or less, more preferably 55 mass % or less, and even more preferably 45 mass % or less, based on the total amount of the polyester resin segment and the addition polymerization resin segment.

The amount of the structural unit derived from the bireactive monomer in the composite resin is preferably 0.1 mass % or more, more preferably 0.5 mass % or more, and even more preferably 0.8 mass % or more, and is preferably 10 mass % or less, more preferably 7 mass % or less, and even more preferably 4 mass % or less, based on the total amount of the polyester resin segment and the addition polymerization resin segment.

The total amount of the polyester resin segment and the addition polymerization resin segment in the composite resin is preferably 80 mass % or more, more preferably 90 mass % or more, and even more preferably 95 mass % or more, and is 100 mass % or less, and preferably 100 mass %.

The above amount is calculated based on the ratio of the amounts of the raw material monomers for the polyester resin segment and the addition polymerization resin segment, the bireactive monomer, and the radical polymerization initiator, and the mass of the polyester resin segment or the like is based on the mass excluding a mass of water generated by polycondensation. When a radical polymerization initiator is used, the mass of the radical polymerization initiator is included in the mass of the addition polymerization resin segment for calculation.

### (Method for Producing Amorphous Polyester-Based Resin A)

### «Method for Producing Amorphous Polyester Resin»

In a case where the resin A is an amorphous polyester resin, the resin A may be produced by, for example, polycondensing raw material monomers including an alcohol component and a carboxylic acid component in the same manner as for the resin C.

### Method for Producing Composite Resin

In a case where the resin A is a composite resin including a polyester resin segment and an addition polymerization resin segment, the resin may be produced by, for example, a method including a step A of polycondensing an alcohol component and a carboxylic acid component and a step B of addition-polymerizing raw material monomers for the addition polymerization resin segment and a bireactive monomer.

Step B may be performed after step A, step A may be performed after step B, or step A and step B may be simultaneously performed.

A method is preferred in which a part of the carboxylic acid component is subjected to a polycondensation reaction in step A, step B is then performed, and, thereafter, the remainder of the carboxylic acid component is added to a polymerization system to further advance the polycondensation reaction in step A and a polycondensation reaction with, for example, a carboxy group possessed by the bireactive monomer or the structural unit derived from the bireactive monomer.

In step A, if necessary, polycondensation may be performed using the esterification catalyst and the esterification co-catalyst described in the above section Method for Producing Crystalline Polyester Resin C in the same amounts.

In addition, when a monomer having an unsaturated bond such as fumaric acid is used in the polycondensation, the polymerization inhibitor described in the above section Method for Producing Crystalline Polyester Resin C may be used in the same amount, if necessary.

The temperature of the polycondensation reaction is preferably 120 °C or higher, more preferably 160 °C or higher, and even more preferably 180 °C or higher, and is preferably 250 °C or lower, and more preferably 240 °C or lower. The polycondensation may be performed in an inert gas atmosphere.

Examples of the radical polymerization initiator for the addition polymerization in step B include peroxides such as dibutyl peroxide, persulfates such as sodium persulfate, and azo compounds such as 2,2′-azobis(2,4-dimethylvaleronitrile).

The amount of the radical polymerization initiator to be used is preferably 1 part by mass or more and 20 parts by mass or less relative to 100 parts by mass of the raw material monomers for the addition polymerization resin segment.

The temperature of the addition polymerization is preferably 110 °C or higher, and more preferably 130 °C or higher, and is preferably 230 °C or lower, more preferably 220 °C or lower, and even more preferably 210 °C or lower.

### (Physical Properties of Amorphous Polyester-Based Resin A)

The softening point of the resin A is preferably 70 °C or higher, more preferably 90 °C or higher, and even more preferably 100 °C or higher, and is preferably 140 °C or lower, more preferably 130 °C or lower, and even more preferably 125 °C or lower.

The glass transition temperature of the resin A is preferably 30 °C or higher, more preferably 35 °C or higher, and even more preferably 40 °C or higher, and is preferably 80 °C or lower, more preferably 75 °C or lower, and even more preferably 70 °C or lower.

The acid value of the resin A is preferably 5 mgKOH/g or more, more preferably 10 mgKOH/g or more, and even more preferably 15 mgKOH/g or more, and is preferably 40 mgKOH/g or less, more preferably 35 mgKOH/g or less, and even more preferably 30 mgKOH/g or less.

The difference between SP_{A} and SP_{C} (SP_{A}−SP_{C}) is preferably 0.50 (cal/cm³)^{1/2} or more, more preferably 0.55 (cal/cm³)^{1/2} or more, even more preferably 0.60 (cal/cm³)^{1/2} or more, and still even more preferably 0.63 (cal/cm³)^{1/2} or more, and is preferably 1.50 (cal/cm³)^{1/2} or less, more preferably 1.30 (cal/cm³)^{1/2} or less, even more preferably 1.00 (cal/cm³)^{1/2} or less, still even more preferably 0.95 (cal/cm³)^{1/2} or less, and yet still even more preferably 0.90 (cal/cm³)^{1/2} or less, from the viewpoints of the compatibility between the resin C and the resin A and the recrystallization of the resin C.

The solubility parameter (SP_{A}) of the resin A is preferably 9.20 (cal/cm³)^{1/2} or more, more preferably 9.50 (cal/cm³)^{1/2} or more, and even more preferably 10.00 (cal/cm³)^{1/2} or more, and is preferably 12.00 (cal/cm³)^{1/2} or less, more preferably 11.80 (cal/cm³)^{1/2} or less, and even more preferably 11.50 (cal/cm³)^{1/2} or less, from the viewpoint of controlling the “SP_{A}−SP_{C}” within the above range. The SP_{A} is a value calculated by the Fedors method.

The softening point, glass transition temperature, acid value, and solubility parameter of the resin A can be appropriately adjusted by the types of the raw material monomers and amounts thereof to be used, and the production conditions such as the reaction temperature, the reaction time, and the cooling rate. Those values are determined by the methods described in Examples below.

When two or more resins A are used in combination, the softening point, glass transition temperature, acid value, and solubility parameter of the obtained mixture thereof preferably fall within the ranges described above.

The content of the amorphous polyester-based resin A in the toner particles is preferably 50 mass % or more, more preferably 55 mass % or more, and even more preferably 60 mass % or more, and is also preferably 87 mass % or less, more preferably 85 mass % or less, and even more preferably 80 mass % or less.

### <Colorant>

In the present invention, the toner particles contain a pigment as a colorant.

Here, when the value obtained by dividing the total number of —NH— and —NH₂ contained in one molecule of the pigment by the molecular weight of the pigment is defined as the NH group amount, the NH group amount of the pigment is 6.0 mmol/g or more. The upper limit is not particularly limited, but is preferably 20.0 mmol/g or less, and more preferably 15.0 mmol/g or less.

The colorant used in the present invention is preferably a yellow organic pigment, and is preferably at least one of an isoindoline-based pigment and a benzimidazolone pigment from the viewpoint of obtaining a desired NH group amount.

Examples of the isoindoline-based pigment include C. I. Pigment Yellow 139 (total number of —NH— and —NH₂ contained in one molecule=5, molecular weight=367, NH group amount=13.6 mmol/g) and C. I. Pigment Yellow 185 (total number of —NH— and —NH₂ contained in one molecule=4, molecular weight=337, NH group amount=11.9 mmol/g).

Examples of the benzimidazolone pigment include C. I. Pigment Yellow 180 (total number of —NH— and —NH₂ contained in one molecule=6, molecular weight=733, amount of NH group=8.2 mmol/lg).

From the viewpoint of obtaining a printed coating film having high fastness, the pigment used in the present invention is preferably at least one selected from C. I. Pigment Yellow 185 and C. I. Pigment Yellow 180.

From the viewpoint of improving dispersibility in the toner particles, the amount of the colorant is preferably 3 parts by mass or more, more preferably 5 parts by mass or more, and even more preferably 7 parts by mass or more, and is preferably 25 parts by mass or less, more preferably 20 parts by mass or less, and even more preferably 15 parts by mass or less, relative to 100 parts by mass of the total of the resin C and the resin A.

The content of the colorant in the toner particles is preferably 3 mass % or more, and more preferably 5 mass % or more, and is preferably 25 mass % or less, more preferably 20 mass % or less, and even more preferably 15 mass % or less.

### <Releasing Agent>

The toner particles of the present invention preferably contain a releasing agent.

Examples of the releasing agent include polypropylene wax, polyethylene wax, and ethylene-propylene copolymer wax; hydrocarbon-based waxes such as microcrystalline wax, paraffin wax, and Fischer-Tropsch wax, and oxides thereof; ester-based waxes such as carnauba wax, montan wax, deoxidized waxes thereof, and fatty acid ester wax; and fatty acid amides, fatty acids, higher alcohols, and fatty acid metal salts. These may be used alone, or two or more thereof may be used in combination.

The melting point of the releasing agent is preferably 60 °C or higher, and more preferably 70 °C or higher, and is preferably 160 °C or lower, more preferably 140 °C or lower, even more preferably 120 °C or lower, and still even more preferably 100 °C or lower.

The content of the releasing agent in the toner particles is preferably 0.1 mass % or more, more preferably 1 mass % or more, and even more preferably 3 mass % or more, and is preferably 20 mass % or less, more preferably 15 mass % or less, and even more preferably 10 mass % or less.

In addition, the toner particles may contain additives such as a charge control agent, a magnetic powder, a fluidity improver, a conductivity modifier, a reinforcing filler such as a fibrous substance, an antioxidant, an antiaging agent, and a cleanability improver.

### (Physical Properties of Toner Particles)

The volume median particle diameter D₅₀ of the toner particles is preferably 2 μm or more, more preferably 3 μm or more, and even more preferably 4 μm or more, and is preferably 10 μm or less, more preferably 8 μm or less, and even more preferably 7 μm or less, from the viewpoint of obtaining a printed coating film having good image quality and from the viewpoint of further improving the cleanability of the toner.

The circularity of the toner particles is preferably 0.950 or more, more preferably 0.955 or more, and even more preferably 0.960 or more from the viewpoint of obtaining a printed coating film (image) with good image quality, and is preferably 0.990 or less, more preferably 0.985 or less, and even more preferably 0.980 or less from the viewpoint of cleanability.

The CV value of the toner particles is preferably 10% or more, more preferably 15% or more, and even more preferably 20% or more from the viewpoint of improving productivity of the toner, and is preferably 40% or less, more preferably 35% or less, and even more preferably 30% or less from the viewpoint of obtaining a printed coating film having high fastness.

The volume median particle diameter D₅₀, the circularity, and the CV value of the toner particles can be measured by the methods described in Examples.

### [Method for Producing Toner]

A method for producing a toner according to an embodiment of the present invention may be any known method such as a melt-kneading method, a phase inversion emulsification method, a suspension polymerization method, or an emulsion aggregation method, but the emulsion aggregation method is preferred.

### <Emulsion Aggregation Method>

The emulsion aggregation method includes a step of aggregating resin particles containing the resin C and the resin A in the same or different particles and a colorant in an aqueous medium and a step of coalescing the resin particles and the colorant.

### (Step of Aggregating Resin Particles)

In the step of aggregating the resin particles, the resin particles containing the resin C and the resin A in the same or different particles and the colorant are aggregated in an aqueous medium to obtain aggregated particles 1. Preferably, the aggregated particles 1 are obtained by mixing a resin particle dispersion containing the resin particles and a colorant particle dispersion containing the colorant, and aggregating these particles. Here, it is preferable to further aggregate a releasing agent in addition to the resin particles and the colorant, and it is more preferable to mix a resin particle dispersion containing the resin particles, a colorant particle dispersion containing the colorant, and a releasing agent particle dispersion containing the releasing agent, and aggregate these particles to obtain the aggregated particles 1. The resin particle dispersion, the colorant particle dispersion, and the releasing agent particle dispersion are more preferably an aqueous dispersion of the resin particles, an aqueous dispersion of the colorant particles, and an aqueous dispersion of the releasing agent particles, respectively.

In the present invention, the aqueous medium used in the aqueous dispersion is a medium containing water as a main component, and the content of the water in the aqueous medium is preferably 70 mass % or more, more preferably 80 mass % or more, and even more preferably 90 mass % or more, and is 100 mass % or less. The water is preferably deionized water or distilled water.

Examples of components other than the water, which can constitute the aqueous medium together with the water include water-soluble organic solvents such as alkyl alcohols having 1 or more and 5 or less carbon atoms; dialkyl ketones having 3 or more and 5 or less carbon atoms such as acetone and methyl ethyl ketone; and cyclic ethers such as tetrahydrofuran. Among them, alkyl alcohols having 1 or more and 5 or less carbon atoms are preferred, and ethanol is more preferred.

### «Method for Producing Resin Particle Dispersion»

The resin particles of the resin C and the resin particles of the resin A may be produced as an aqueous dispersion of resin particles containing the resin C and the resin A in the same or different particles.

The dispersion can be performed by using a known method, but is preferably performed by a phase inversion emulsification method. Examples of the phase inversion emulsification method include a method in which an aqueous medium is added to an organic solvent solution of the resin C and/or the resin A or molten resin C and/or resin A to perform phase inversion emulsification. The method in which an aqueous medium is added to an organic solvent solution of the resin C and/or the resin A to perform phase inversion emulsification is preferred.

The organic solvent used in the phase inversion emulsification is not particularly limited as long as it dissolves the resin C and the resin A and is water-soluble, and examples thereof include methyl ethyl ketone.

A neutralizing agent may be added to the organic solvent solution. Examples of the neutralizing agent include basic substances. Examples of the basic substances include hydroxides of alkali metals such as sodium hydroxide and potassium hydroxide; and nitrogen-containing basic substances such as ammonia, trimethylamine, and diethanolamine. Among them, alkali metal hydroxides such as sodium hydroxide and potassium hydroxide are preferred.

The degree of neutralization of the resin C and/or the resin A contained in the resin particles is preferably 10 mol % or more, more preferably 20 mol % or more, even more preferably 30 mol % or more, and still even more preferably 40 mol % or more, and is preferably 100 mol % or less, more preferably 80 mol % or less, and even more preferably 70 mol % or less.

The degree of neutralization of the resin C and/or the resin A contained in the resin particles can be determined by the following equation.

Degree of neutralization (mol %)=[{mass (g) of neutralizing agent added/equivalent of neutralizing agent}/[{weighted average acid value (mgKOH/g) of resin constituting resin particles×mass (g) of resin constituting resin particles}/(56×1000)]]×100

While stirring the organic solvent solution or the molten resin C and/or resin A, the aqueous medium is gradually added to cause phase inversion.

The temperature of the organic solvent solution when the aqueous medium is added is preferably a temperature equal to or higher than the glass transition temperature of the resin A, more preferably 60 °C or higher, and even more preferably 70 °C or higher, and is also preferably 100 °C or lower, more preferably 90 °C or lower, and even more preferably 80 °C or lower, from the viewpoint of improving dispersion stability of the resin particles containing the resin C and/or the resin A.

After the phase inversion emulsification, if necessary, the organic solvent may be removed from the obtained dispersion by distillation or the like. Alternatively, the resin particles may be isolated by filtration or the like. It is preferable to use an aqueous dispersion of resin particles obtained by removing the organic solvent from the dispersion obtained after the phase inversion emulsification. In this case, the residual amount of the organic solvent in the dispersion is preferably 1 mass % or less, more preferably 0.5 mass % or less, and even more preferably substantially 0 mass %.

The volume median particle diameter D₅₀ of the resin particles in the dispersion is preferably 0.05 μm or more, and more preferably 0.08 μm or more, and is preferably 1 μm or less, more preferably 0.5 μm or less, and even more preferably 0.3 μm or less.

The CV value of the resin particles in the dispersion is preferably 10% or more, and more preferably 20% or more, and is preferably 40% or less, and more preferably 35% or less. The volume median particle diameter D₅₀ and CV value of the resin particles in the dispersion are measured by the methods described in Examples.

The solid content concentration of the aqueous dispersion of the resin particles is preferably 5 mass % or more, more preferably 10 mass % or more, and even more preferably 15 mass % or more, and is preferably 50 mass % or less, more preferably 40 mass % or less, and even more preferably 30 mass % or less, from the viewpoint of improving the productivity of the toner and improving dispersion stability of the aqueous dispersion of the resin particles.

The solid content is the total amount of nonvolatile components.

In addition, in the step of aggregating the resin particles, the aggregated particles 1 may contain a releasing agent and may also contain additives such as a charge control agent, a magnetic powder, a fluidity improver, a conductivity modifier, a reinforcing filler such as a fibrous substance, an antioxidant, an antiaging agent, and a cleanability improver.

### «Method for Producing Colorant Particle Dispersion»

The colorant particle dispersion is preferably obtained by dispersing a pigment and an aqueous medium using a disperser such as a homomixer, a homogenizer, or an ultrasonic disperser. The dispersion is preferably performed in the presence of a surfactant from the viewpoint of improving dispersion stability of the pigment.

From the viewpoint of improving the dispersion stability of the pigment, the pigment may be dispersed in the presence of an addition polymer E. The addition polymer E preferably has a structural unit derived from an addition polymerizable monomer a having an aromatic group, and preferably further contains at least one selected from the group consisting of an addition polymerizable monomer b having an ionic group, an addition polymerizable monomer c having a polyalkylene oxide group, and a macromonomer d. With respect to the colorant particle dispersion using the addition polymer E, reference is made to the addition polymer E described in JP 2021-026129 A.

Examples of the surfactant that improves the dispersion stability of the pigment include a nonionic surfactant, an anionic surfactant, and a cationic surfactant. From the viewpoint of improving the dispersion stability of the pigment, a nonionic surfactant is preferred. Examples of the nonionic surfactant include polyoxyalkylene alkyl ethers, polyoxyalkylene alkenyl ethers, and polyoxyalkylene aryl ethers. Among them, polyoxyethylene aryl ethers are preferred, and polyoxyethylene distyrenated phenyl ethers are more preferred.

From the viewpoint of improving the dispersion stability of the pigment, the content of the surfactant in the colorant particle dispersion is preferably 1 part by mass or more, more preferably 5 parts by mass or more, and even more preferably 10 parts by mass or more, and is preferably 50 parts by mass or less, more preferably 45 parts by mass or less, and even more preferably 40 parts by mass or less, relative to 100 parts by mass of the pigment.

The content of the pigment in the colorant particle dispersion is preferably 5 mass % or more, and more preferably 10 mass % or more, and is preferably 50 mass % or less, more preferably 40 mass % or less, and even more preferably 30 mass % or less.

The solid content concentration of the colorant particle dispersion is preferably 5 mass % or more, more preferably 10 mass % or more, and even more preferably 15 mass % or more, and is preferably 50 mass % or less, more preferably 40 mass % or less, and even more preferably 30 mass % or less.

The volume median particle diameter D₅₀ of the colorant particles is preferably 0.05 μm or more, more preferably 0.08 μm or more, and even more preferably 0.1 μm or more, and is preferably 0.4 μm or less, more preferably 0.3 μm or less, and even more preferably 0.2 μm or less, from the viewpoint of improving dispersibility in the toner particles.

The CV value of the colorant particles is preferably 10% or more, and more preferably 20% or more, and is preferably 45% or less, more preferably 40% or less, and even more preferably 35% or less, from the viewpoint of improving dispersibility in the toner particles.

The volume median particle diameter D₅₀ and CV value of the colorant particles are measured by the methods described in Examples.

### (Method for Producing Releasing Agent Particle Dispersion)

The releasing agent particle dispersion is obtained by, for example, dispersing the releasing agent, a dispersion of resin particles S described below, and, if necessary, an aqueous medium at a temperature equal to or higher than the melting point of the releasing agent using a disperser such as a homogenizer, a high-pressure disperser, or an ultrasonic disperser.

The heating temperature at the time of dispersion is preferably a temperature equal to or higher than the melting point of the releasing agent and 80 °C or higher, more preferably 85 °C or higher, and even more preferably 90 °C or higher, and is preferably 100 °C or lower, more preferably 98 °C or lower, and even more preferably 96 °C or lower.

The releasing agent particle dispersion can also be obtained by using a surfactant, but is preferably obtained by mixing the releasing agent with the resin particles S described below. When the releasing agent particles are prepared using the releasing agent and the resin particles S, the releasing agent particles are stabilized by the resin particles S, and the releasing agent can be dispersed in the aqueous medium without using a surfactant. It is considered that, in the releasing agent particle dispersion, a structure is present in which a large number of the resin particles S are attached to surfaces of the releasing agent particles.

The resin constituting the resin particles S in which the releasing agent is dispersed is preferably a polyester-based resin, and more preferably a composite resin D having a polyester resin segment and an addition polymerization resin segment. For the composite resin D, reference is made to, for example, JP 2021-026129 A.

The solubility parameter (SPD) of the composite resin D may be about the same as SP_{A} from the viewpoint of affinity with the resin A.

From the viewpoint of obtaining uniform aggregated particles by aggregation, the volume median particle diameter D₅₀ of the releasing agent particles in the releasing agent particle dispersion is preferably 0.05 μm or more, more preferably 0.2 μm or more, and even more preferably 0.4 μm or more, and is preferably 1 μm or less, more preferably 0.8 μm or less, and even more preferably 0.6 μm or less.

The CV value of the releasing agent particles in the releasing agent particle dispersion is preferably 10% or more, and more preferably 20% or more, and is preferably 40% or less, more preferably 35% or less, and even more preferably 30% or less.

The volume median particle diameter D₅₀ and CV value of the releasing agent particles in the releasing agent particle dispersion are measured by the methods described in Examples.

### —Surfactant—

In the step of aggregating the resin particles, when the dispersions of the respective particles are mixed to prepare a mixed dispersion, the mixing may be performed in the presence of a surfactant from the viewpoint of improving the dispersion stabilities of the resin particles, the releasing agent particles, the colorant particles, and the like. Examples of the surfactant include anionic surfactants such as alkylbenzene sulfonates and alkyl ether sulfates; and nonionic surfactants such as polyoxyethylene alkyl ethers and polyoxyethylene alkenyl ethers.

When the surfactant is used, the total amount thereof to be used is preferably 0.1 parts by mass or more, more preferably 0.3 parts by mass or more, and even more preferably 0.5 parts by mass or more, and is preferably 10 parts by mass or less, more preferably 5 parts by mass or less, and even more preferably 3 parts by mass or less, relative to 100 parts by mass of the total amount of the resin C and the resin A.

### —Aggregating Agent—

In the step of aggregating the resin particles, it is preferable to add an aggregating agent from the viewpoint of efficient aggregation.

Examples of the aggregating agent include cationic surfactants such as quaternary salts, organic aggregating agents such as polyethyleneimine, and inorganic aggregating agents. Examples of the inorganic aggregating agent include inorganic metal salts such as sodium sulfate, sodium nitrate, sodium chloride, calcium chloride, and calcium nitrate; inorganic ammonium salts such as ammonium sulfate, ammonium chloride, and ammonium nitrate; and bivalent or higher valent metal complexes.

From the viewpoints of improving aggregation properties and obtaining uniform aggregated particles 1, a monovalent or higher valent and pentavalent or lower valent inorganic aggregating agent is preferred, a monovalent or higher valent and bivalent or lower valent inorganic metal salt, or an inorganic ammonium salt is more preferred, an inorganic ammonium salt is even more preferred, and ammonium sulfate is still even more preferred.

Using an aggregating agent, for example, 5 parts by mass or more and 50 parts by mass or less of the aggregating agent, relative to 100 parts by mass of the resin in the resin particles, is added to a mixed dispersion, at 0 °C or higher and 40 °C or lower, containing the resin particles, the releasing agent particles, and the colorant particles to aggregate the resin particles, the releasing agent particles, and the colorant particles in an aqueous medium to obtain the aggregated particles 1. Furthermore, from the viewpoint of promoting aggregation, it is preferable to raise the temperature of the dispersion after addition of the aggregating agent.

Examples of a method of terminating the aggregation include a method of cooling the dispersion, a method of adding an aggregation stopping agent, and a method of diluting the dispersion. From the viewpoint of reliably preventing unnecessary aggregation, the method of terminating the aggregation by adding an aggregation stopping agent is preferred.

### Aggregation Stopping Agent

The aggregation stopping agent is preferably a surfactant, and more preferably an anionic surfactant. The anionic surfactant includes, for example, alkylbenzene sulfonates, alkyl sulfates, alkyl ether sulfates, polyoxyalkylene alkyl ether sulfates, aryl sulfonates, and arylsulfonic acid-formalin condensates, and is preferably an alkali metal salt of an arylsulfonic acid-formalin condensate, and more preferably a sodium salt of a naphthalenesulfonic acid-formalin condensate. These may be used alone, or two or more thereof may be used in combination. The aggregation stopping agent may be added as an aqueous solution.

The amount of the aggregation stopping agent to be added is preferably 1 part by mass or more, and more preferably 5 parts by mass or more from the viewpoint of reliably preventing unnecessary aggregation, and is preferably 60 parts by mass or less, more preferably 30 parts by mass or less, and even more preferably 20 parts by mass or less from the viewpoint of reducing residues in the toner, relative to 100 parts by mass of the total of the resin C and the resin A.

The volume median particle diameter D₅₀ of the aggregated particles 1 is preferably 2 μm or more, more preferably 3 μm or more, and even more preferably 4 μm or more, and is preferably 10 μm or less, more preferably 8 μm or less, and even more preferably 7 μm or less.

In the present invention, after the step of aggregating the resin particles and before the step of coalescing the resin particles, a step of attaching resin particles for a shell containing an amorphous resin (preferably an amorphous polyester-based resin B) to the obtained aggregated particles 1 and aggregating the resin particles to obtain aggregated particles 2 may be included. Toner particles having a core-shell structure can be obtained by incorporating the step of aggregating the resin particles for a shell.

Examples of the amorphous polyester-based resin B used in the resin particles for a shell include the resin A described above. The resin particles for a shell are obtained by the same method as the method for producing the resin particles containing the resin C and/or the resin A described above.

When the method for producing a toner includes a step of aggregating the resin particles for a shell, the aggregation is preferably terminated at a time point when the aggregated particles 2 have grown to an appropriate particle diameter as toner particles in the step, and a method of terminating the aggregation by adding the aggregation stopping agent is preferred.

The ratio of the mass of the resin particles for a shell to the mass of the aggregated particles 1 [resin particles for a shell/aggregated particles 1] is preferably 1/99 or more, more preferably 3/97 or more, and even more preferably 5/95 or more, and is preferably 25/75 or less, more preferably 20/80 or less, and even more preferably 15/85 or less, from the viewpoint of low-temperature fusing property of the toner.

### Coalescing Step

In the coalescing step, for example, the aggregated particles 1 or aggregated particles 2 are coalesced in an aqueous medium.

By the coalescing, the respective particles contained in the aggregated particles 1 or the aggregated particles 2 are coalesced to each other to obtain coalesced particles.

In the coalescing step, the temperature is held at a temperature equal to or higher than the glass transition temperature of the resin having the highest glass transition temperature among the amorphous polyester-based resins contained in the aggregated particles, from the viewpoint of improving the coalescing properties of the aggregated particles 1 or the aggregated particles 2 and from the viewpoint of improving the low-temperature fusing property of the toner.

From the viewpoint of improving coalescing properties of the aggregated particles and enhancing productivity of the toner, the temperature to be maintained at the time of coalescing the aggregated particles is preferably not lower than a temperature higher by 2 °C than the maximum value of glass transition temperatures of the resin(s) among the amorphous polyester-based resins, more preferably not lower than a temperature higher by 3 °C than the maximum value of glass transition temperatures, and even more preferably not lower than a temperature higher by 5 °C than the maximum value of glass transition temperatures. The temperature to be maintained at the time of coalescing the aggregated particles is also preferably not higher than a temperature higher by 30 °C than the maximum value of glass transition temperatures of the resin(s) among the amorphous polyester-based resins, more preferably not higher than a temperature higher by 25 °C than the maximum value of glass transition temperatures, and even more preferably not higher than a temperature higher by 20 °C than the maximum value of glass transition temperatures.

In this case, from the viewpoint of improving the low-temperature fusing property of the toner, the time during which the temperature is held at a temperature equal to or higher than the glass transition temperature of the amorphous polyester-based resin is preferably 1 minute or more, more preferably 10 minutes or more, and even more preferably 30 minutes or more, and is preferably 240 minutes or less, more preferably 180 minutes or less, even more preferably 120 minutes or less, and even more preferably 90 minutes or less.

It is preferable to hold the temperature at the above temperature until a desired circularity is obtained.

The volume median particle diameter D₅₀ of the coalesced particles obtained by coalescing is preferably 2 μm or more, more preferably 3 μm or more, and even more preferably 4 μm or more, and is preferably 10 μm or less, more preferably 8 μm or less, and even more preferably 7 μm or less.

The circularity of the coalesced particles obtained by coalescing is preferably 0.955 or more, and more preferably 0.960 or more, and is preferably 0.990 or less, more preferably 0.985 or less, and even more preferably 0.980 or less.

The coalescing is preferably ended after the above-mentioned preferred circularity is reached.

The circularity is measured by the method described in Examples.

### Post-Treatment Step

The coalescing step may be followed by a post-treatment step in which toner particles are obtained by isolating the coalesced particles. Since the coalesced particles obtained in the coalescing step are present in the aqueous medium, solid-liquid separation is preferably performed first. For the solid-liquid separation, a suction filtration method or the like is preferably used.

Washing is preferably performed after the solid-liquid separation. At this time, since it is preferable to also remove the added surfactant, it is preferable to perform washing with an aqueous medium at a temperature equal to or lower than a cloud point of the surfactant. Washing is preferably performed a plurality of times.

Then, drying is preferably performed. Examples of a drying method include a vacuum low-temperature drying method, a vibration-type fluidized drying method, a spray drying method, a freeze drying method, and a flash jet method.

### Melt-Kneading Method

In the present invention, the melt-kneading method involves, for example, uniformly mixing the binder resin, the colorant and, if necessary, additives such as a releasing agent using a mixer such as a Henschel mixer, and then melt-kneading the mixture using a closed kneader, a single-screw or double-screw extruder, an open-roll kneader or the like. Subsequently, toner particles can be obtained by cooling, pulverization, and classification.

The toner includes toner particles. The obtained toner particles can be used as the toner of the present invention as they are. In addition, it is preferable to use toner particles whose surfaces have been supplemented and treated with an external additive as the toner of the present invention.

### External Additive

Examples of the external additive include fine particles of inorganic materials such as hydrophobic silica, titanium oxide, alumina, cerium oxide, and carbon black, and fine particles of polymers such as polycarbonate, polymethyl methacrylate, and a silicone resin. Among them, hydrophobic silica is preferred. The external additives may be used alone, or two or more thereof may be used in combination. Two or more types of hydrophobic silica having different particle diameters may be used.

In a case where the surface treatment of the toner particles is performed using the external additive, the amount of the external additive to be added is preferably 1 part by mass or more, more preferably 2 parts by mass or more, and even more preferably 3 parts by mass or more, and is preferably 5 parts by mass or less, more preferably 4.5 parts by mass or less, and even more preferably 4 parts by mass or less relative to 100 parts by mass of the toner particles.

The toner is used in electrostatic image development in electrophotographic printing. The toner can be used, for example, as a one-component developer or as a two-component developer mixed with a carrier.

In addition to the above embodiments, the present invention discloses the following embodiments.

<1>

An electrostatic image development toner containing a crystalline polyester resin C, an amorphous polyester-based resin A, and a colorant, in which
the crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and
the colorant is a pigment having a NH group amount of 6.0 mmol/g or more, the NH group amount being obtained by dividing a total number of —NH— and —NH₂ contained in one molecule of the pigment by a molecular weight of the pigment.
   <2>

The electrostatic image development toner according to <1>, in which the crystalline polyester resin C further includes a structural unit derived from a monocarboxylic acid component having 6 or more and 24 or less carbon atoms.

<3>

The electrostatic image development toner according to <2>, in which the number of carbon atoms of the structural unit derived from the monocarboxylic acid component having 6 or more and 24 or less carbon atoms is preferably 8 or more, more preferably 12 or more, even more preferably 14 or more, and still even more preferably 16 or more, and is preferably 22 or less, and more preferably 20 or less.

<4>

The electrostatic image development toner according to <2> or <3>, in which a content of the structural unit derived from the monocarboxylic acid component having 6 or more and 24 or less carbon atoms is 1 mol % or more, preferably 5 mol % or more, and more preferably 7 mol % or more, and is 35 mol % or less, preferably 30 mol % or less, more preferably 20 mol % or less, and even more preferably 15 mol % or less, in the structural unit derived from the carboxylic acid component of the crystalline polyester resin C.

<5>

The electrostatic image development toner according to any one of <1> to <4>, in which the structural unit derived from the aliphatic dicarboxylic acid component having 10 or more and 14 or less carbon atoms includes a structural unit derived from an α,ω-linear aliphatic dicarboxylic acid component having 10 or more and 14 or less carbon atoms.

<6>

The electrostatic image development toner according to any one of <1> to <5>, in which the structural unit derived from the aliphatic dicarboxylic acid component having 10 or more and 14 or less carbon atoms includes at least one selected from a structural unit derived from sebacic acid, a structural unit derived from 1,11-undecanoic diacid, a structural unit derived from 1,12-dodecanedioic acid, a structural unit derived from 1,13-tridecanedioic acid, and a structural unit derived from 1,14-tetradecanedioic acid, preferably at least one selected from a structural unit derived from sebacic acid, a structural unit derived from 1,12-dodecanedioic acid, and a structural unit derived from 1,14-tetradecanedioic acid, and more preferably a structural unit derived from 1,12-dodecanedioic acid and/or a structural unit derived from 1,14-tetradecanedioic acid.

<7>

The electrostatic image development toner according to any one of <1> to <6>, in which a content of the structural unit derived from the aliphatic diol component is 80 mol % or more, preferably 85 mol % or more, more preferably 90 mol % or more, and even more preferably 95 mol % or more, and is 100 mol % or less, in a structural unit derived from an alcohol component of the crystalline polyester resin C.

<8>

The electrostatic image development toner according to any one of <1> to <7>, in which a content of a structural unit derived from ethylene glycol is 65 mol % or more, preferably 85 mol % or more, more preferably 90 mol % or more, and even more preferably 95 mol % or more, and is 100 mol % or less, in the structural unit derived from the alcohol component of the crystalline polyester resin C.

<9>

The electrostatic image development toner according to any one of <1> to <8>, in which a content of the structural unit derived from the aliphatic dicarboxylic acid having 10 or more and 14 or less carbon atoms is 70 mol % or more, preferably 75 mol % or more, more preferably 80 mol % or more, and even more preferably 85 mol % or more, and is 100 mol % or less, in the structural unit derived from the carboxylic acid component of the crystalline polyester resin C.

<10>

The electrostatic image development toner according to any one of <1> to <9>, in which the crystalline polyester resin C has an ester group concentration of 6.7 mmol/g or more and 8.8 mmol/g or less, preferably 8.6 mmol/g or less.

<11>

The electrostatic image development toner according to any one of <1> to <10>, in which the crystalline polyester resin C has a softening point of 60 °C or higher, preferably 65 °C or higher, and more preferably 70 °C or higher, and of 150 °C or lower, preferably 120 °C or lower, and more preferably 100 °C or lower.

<12>

The electrostatic image development toner according to any one of <1> to <11>, in which the crystalline polyester resin C has a melting point of 50 °C or higher, preferably 60 °C or higher, and more preferably 70 °C or higher, and of 100 °C or lower, preferably 95 °C or lower, and more preferably 90 °C or lower.

<13>

The electrostatic image development toner according to any one of <1> to <12>, in which the crystalline polyester resin C has a solubility parameter of 8.70 (cal/cm³)^{1/2} or more, preferably 9.00 (cal/cm³)^{1/2} or more, and more preferably 9.50 (cal/cm³)^{1/2} or more, and of 11.00 (cal/cm³)^{1/2} or less, preferably 10.50 (cal/cm³)^{1/2} or less, and more preferably 10.20 (cal/cm³)^{1/2} or less.

<14>

The electrostatic image development toner according to any one of <1> to <13>, in which a structural unit derived from an alcohol component of the amorphous polyester-based resin A includes at least one selected from a structural unit derived from an alkylene oxide adduct of an aromatic diol, a structural unit derived from a linear or branched aliphatic diol, a structural unit derived from an alicyclic diol, and a structural unit derived from a trihydric or higher polyhydric alcohol, preferably a structural unit derived from an alkylene oxide adduct of an aromatic diol and/or a structural unit derived from a linear or branched aliphatic diol.

<15>

The electrostatic image development toner according to any one of <1> to <14>, in which the structural unit derived from the alcohol component of the amorphous polyester-based resin A includes a structural unit derived from an alkylene oxide adduct of an aromatic diol, preferably a structural unit derived from an alkylene oxide adduct of bisphenol A, more preferably a structural unit derived from an alkylene oxide adduct of 2,2-bis(4-hydroxyphenyl)propane represented by Formula (I) below, even more preferably a structural unit derived from a propylene oxide adduct of bisphenol A and/or a structural unit derived from an ethylene oxide adduct of bisphenol A, and even more preferably a structural unit derived from a propylene oxide adduct of bisphenol A:

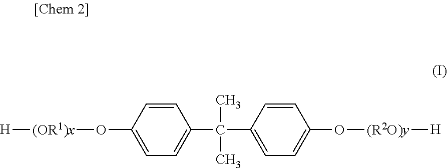

where OR¹ and R²O represent oxyalkylene groups, R¹ and R² each independently represent an ethylene group or a propylene group, x and y represent average numbers of moles of alkylene oxide added and are each a positive number, and a sum value of x and y is 1 or more, and preferably 1.5 or more, and is 16 or less, preferably 8 or less, and more preferably 4 or less.

<16>

The electrostatic image development toner according to <15>, in which a content of the structural unit derived from the alkylene oxide adduct of bisphenol A is 80 mol % or more, and preferably 90 mol % or more, and is 100 mol % or less, in the structural unit derived from the alcohol component of the amorphous polyester-based resin A.

<17>

The electrostatic image development toner according to any one of <1> to <14>, in which the structural unit derived from the alcohol component of the amorphous polyester-based resin A includes the structural unit derived from the linear or branched aliphatic diol.

<18>

The electrostatic image development toner according to <17>), in which the structural unit derived from the linear or branched aliphatic diol includes a structural unit derived from neopentyl glycol, and a content of the structural unit derived from the neopentyl glycol is 65 mol % or more, preferably 85 mol % or more, more preferably 90 mol % or more, and even more preferably 95 mol % or more, and is 100 mol % or less, in the structural unit derived from the linear or branched aliphatic diol.

<19>

The electrostatic image development toner according to any one of <1> to <18>, in which a structural unit derived from a carboxylic acid component of the amorphous polyester-based resin A includes at least one selected from a structural unit derived from an aromatic dicarboxylic acid, a structural unit derived from a linear or branched aliphatic dicarboxylic acid, and a structural unit derived from an alicyclic dicarboxylic acid, preferably at least one selected from a structural unit derived from an aromatic dicarboxylic acid and a structural unit derived from a linear or branched aliphatic dicarboxylic acid.

<20>

The electrostatic image development toner according to any one of <1> to <19>, in which the structural unit derived from the aromatic dicarboxylic acid includes at least one selected from a structural unit derived from phthalic acid, a structural unit derived from isophthalic acid, and a structural unit derived from terephthalic acid, preferably a structural unit derived from isophthalic acid and/or a structural unit derived from terephthalic acid, and more preferably a structural unit derived from terephthalic acid.

<21>

The electrostatic image development toner according to any one of <1> to <20>, in which the amorphous polyester-based resin A has a softening point of 70 °C or higher, preferably 90 °C or higher, and more preferably 100 °C or higher, and of 140 °C or lower, preferably 130 °C or lower, and more preferably 125 °C or lower.

<22>

The electrostatic image development toner according to any one of <1> to <21>, in which the amorphous polyester-based resin A has a glass transition temperature of 30 °C or higher, preferably 35 °C or higher, and more preferably 40 °C or higher, and of 80 °C or lower, preferably 75 °C or lower, and more preferably 70 °C or lower.

<23>

The electrostatic image development toner according to any one of <1> to <22>, in which the amorphous polyester-based resin A has a solubility parameter of 9.20 (cal/cm³)^{1/2} or more, preferably 9.50 (cal/cm³)^{1/2} or more, and more preferably 10.00 (cal/cm³)^{1/2} or more, and of 12.00 (cal/cm³)^{1/2} or less, preferably 11.80 (cal/cm³)^{1/2} or less, and more preferably 11.50 (cal/cm³)^{1/2} or less.

<24>

The electrostatic image development toner according to any one of <1> to <23>, in which a difference in a solubility parameter between the amorphous polyester-based resin A and the crystalline polyester resin C is 0.50 (cal/cm³)^{1/2} or more, preferably 0.55 (cal/cm³)^{1/2} or more, more preferably 0.60 (cal/cm³)^{1/2} or more, and even more preferably 0.63 (cal/cm³)^{1/2} or more, and is 1.50 (cal/cm³)^{1/2} or less, preferably 1.30 (cal/cm³)^{1/2} or less, more preferably 1.00 (cal/cm³)^{1/2} or less, even more preferably 0.95 (cal/cm³)^{1/2} or less, and still even more preferably 0.90 (cal/cm³)^{1/2} or less.

<25>

The electrostatic image development toner according to any one of <1> to <24>, in which a mass ratio of a content of the amorphous polyester-based resin A to a content of the crystalline polyester resin C is 55/45 or more, preferably 60/40 or more, and more preferably 65/35 or more, and is 90/10 or less, preferably 85/15 or less, and more preferably 78/22 or less.

<26>

The electrostatic image development toner according to any one of <1> to <25>, in which the colorant is a pigment having a NH group amount of 6.0 mmol/g or more, the NH group amount being obtained by dividing a total number of —NH— and —NH₂ contained in one molecule of the pigment by a molecular weight of the pigment, and the NH group amount is 20.0 mmol/g or less, preferably 15.0 mmol/g or less.

<27>

The electrostatic image development toner according to any one of <1> to <26>, in which the colorant is a yellow organic pigment.

<28>

The electrostatic image development toner according to any one of <1> to <27>, in which the colorant includes at least one selected from an isoindoline-based pigment and a benzimidazolone pigment.

<29>

The electrostatic image development toner according to any one of <1> to <28>, in which the colorant is at least one selected from C. I. Pigment Yellow 185 and C. I. Pigment Yellow 180.

<30>

The electrostatic image development toner according to any one of <1> to <29>, in which a content of the colorant is 3 parts by mass or more, preferably 5 parts by mass or more, and more preferably 7 parts by mass or more, and is 25 parts by mass or less, preferably 20 parts by mass or less, and more preferably 15 parts by mass or less, relative to 100 parts by mass of a total of the crystalline polyester resin C and the amorphous polyester-based resin A.

<31>

The electrostatic image development toner according to any one of <1> to <30>, in which the electrostatic image development toner includes toner particles, and a content of the colorant in the toner particles is 3 mass % or more, and preferably 5 mass % or more, and is 25 mass % or less, preferably 20 mass % or less, and more preferably 15 mass % or less.

<32>

The electrostatic image development toner according to any one of <1> to <31>, in which the electrostatic image development toner has a core-shell structure.

<33>

A method for producing an electrostatic image development toner, the method including: a step of aggregating resin particles containing a crystalline polyester resin C and an amorphous polyester-based resin A in the same or different particles and a colorant in an aqueous medium; and a step of coalescing the resin particles and the colorant, in which
the crystalline polyester resin C includes a structural unit derived from an aliphatic diol component containing ethylene glycol and a structural unit derived from an aliphatic dicarboxylic acid component having 10 or more and 14 or less carbon atoms, and has an ester group concentration of 6.5 mmol/g or more and 9.0 mmol/g or less, and
the colorant is a pigment having a NH group amount of 6.0 mmol/g or more, the NH group amount being obtained by dividing a total number of —NH— and —NH₂ contained in one molecule of the pigment by a molecular weight of the pigment.
   <34>

The method for producing an electrostatic image development toner according to <33>, including, after the aggregating step and before the coalescing step, a step of attaching resin particles for a shell containing an amorphous resin to aggregated particles 1 obtained in the aggregating step and aggregating the particles to obtain aggregated particles 2.

<35>

The method for producing an electrostatic image development toner according to <34>, in which a ratio of the mass of the resin particles for a shell to a mass of the aggregated particles 1 [resin particles for a shell/aggregated particles 1] is 1/99 or more, preferably 3/97 or more, and more preferably 5/95 or more, and is 25/75 or less, preferably 20/80 or less, and more preferably 15/85 or less.

### EXAMPLES

Hereinafter, the present invention will be specifically described with reference to Examples, but is not limited by these Examples.

In the notation such as “alkylene oxide (X)”, the numerical value X put in parentheses means an average number of moles of alkylene oxide added.

### [Measurement Method]

The property values of the polyester resin, the resin particles, the toner, and the like were measured and evaluated by the following methods.

### [Softening Point, Crystallinity Index, Melting Point, and Glass Transition Temperature of Resin]

### (1) Softening Point

Using a flow tester “CFT-500D” (available from Shimadzu Corporation), a load of 1.96 MPa was applied, with a plunger, to 1 g of a sample while heating the sample at a rate of temperature increase of 6 °C/min, and the sample was extruded from a nozzle having a diameter of 1 mm and a length of 1 mm. The plunger descending amount of the flow tester was plotted against the temperature, and the temperature at which half of the sample flowed out was defined as the softening point.

### (2) Crystallinity Index

Using a differential scanning calorimeter “Q100” (available from TA Instruments Japan Inc.), the sample (0.02 g) was weighed in an aluminum pan and cooled to 0 °C at a rate of temperature decrease of 10 °C/min. Then, the sample was allowed to stand still as is for 1 minute, and then subjected to a temperature increase to 180 °C at a rate of temperature increase of 10 °C/min to measure the amount of heat. The crystallinity index was determined by (softening point (°C))/(maximum endothermic peak temperature (1) (°C)), where the temperature of the peak having the largest peak area among the endothermic peaks observed was defined as maximum endothermic peak temperature (1).

### (3) Melting Point and Glass Transition Temperature

Using a differential scanning calorimeter “Q100” (available from TA Instruments Japan Inc.), the sample (0.02 g) was weighed in an aluminum pan, subjected to a temperature increase to 200 °C, and cooled from the temperature to 0 °C at a rate of temperature decrease of 10 °C/min. Then, the sample was subjected to a temperature increase at a rate of temperature increase of 10 °C/min to measure the amount of heat. Among the endothermic peaks observed, the temperature of the peak having the largest peak area was defined as a maximum endothermic peak temperature (2). In the case of a crystalline resin, the peak temperature was taken as the melting point.

In addition, in the case of an amorphous resin, when a peak was observed, the temperature of the peak was taken as the glass transition temperature, and when no peak was observed but a step was observed, the temperature at a point of intersection between a tangent showing the maximum slope of the curve of the step portion and an extended line of the base line on the low temperature side of the step was taken as the glass transition temperature.

### [Acid Value of Resin]

The acid value of the resin was measured according to JIS K0070:1992. However, the measurement solvent was a mixed solvent of acetone and toluene (acetone:toluene=1:1 (volume ratio)).

### [Melting Point of Releasing Agent]

Using a differential scanning calorimeter “Q100” (available from TA Instruments Japan Inc.), the sample (0.02 g) was weighed in an aluminum pan, subjected to a temperature increase to 200 °C, and then cooled from 200 °C to 0 °C at a rate of temperature decrease of 10 °C/min. Then, the sample was subjected to a temperature increase at a rate of temperature increase of 10 °C/min to measure the amount of heat, and the maximum endothermic peak temperature was taken as the melting point.

### [Volume Median Particle Diameters D₅₀ and CV Values of Resin Particles, Colorant Particles, and Releasing Agent Particles]

(1) Measurement apparatus: laser diffraction-type particle diameter measuring instrument “LA-920” (available from HORIBA, Ltd.)

(2) Measurement conditions: The sample dispersion was placed in a measurement cell, distilled water was added thereto, and the volume median particle diameter D₅₀ and a volume average particle diameter Dv were measured at a concentration at which the absorbance was in an appropriate range. The CV value was calculated according to the following equation.

CV value (%)=(standard deviation of particle diameter distribution/volume average particle diameter Dv)×100

### [Solid Content Concentrations of Resin Particle Dispersion, Colorant Particle Dispersion, and Releasing Agent Particle Dispersion]

Using an infrared moisture meter “FD-230” (available from Kett Electric Laboratory Co., Ltd.), the moisture content (mass %) of 5 g of the measurement sample was measured at a drying temperature of 150 °C in a measurement mode 96 (monitoring time: 2.5 minutes, fluctuation range of moisture content: 0.05%). The solid content concentration was calculated according to the following equation.

Solid content concentration (mass %)=100−moisture content (mass %)

### [Volume Median Particle Diameter D₅₀ of Aggregated Particles]

Measuring instrument: “Coulter Multisizer (trade name) III” (available from Beckman Coulter, Inc.)
Aperture diameter: 50 μm
Analysis software: “Multisizer (registered trade name) III version 3.51” (available from Beckman Coulter, Inc.)
Electrolytic solution: “ISOTON (trade name) II” (available from Beckman Coulter, Inc.)
Measurement conditions: The sample dispersion was added to 100 mL of the electrolytic solution to adjust the concentration so that the particle diameter of 30000 particles could be measured in 20 seconds. Then, 30000 particles were measured again, and the volume median particle diameter D₅₀ was determined from the particle diameter distribution thereof.

### [Circularity of Coalesced Particles]

Measurement apparatus: flow-type particle image analyzer “FPIA-3000” (available from Sysmex Corporation)
Preparation of dispersion: The dispersion of the coalesced particles was diluted with deionized water so as to attain a solid content concentration of from 0.001 to 0.05 mass %.
Measurement mode: HPF measurement mode

### [Volume Median Particle Diameter D₅₀ and CV Value of Toner Particles]

The measurement apparatus, aperture diameter, analysis software, and electrolytic solution used were the same as those used in the measurement of the volume median particle diameter D₅₀ of the aggregated particles described above.
Dispersion: polyoxyethylene lauryl ether “EMULGEN (trade name) 109P” (available from Kao Corporation, hydrophile-lipophile balance (HLB)=13.6) was dissolved in the electrolytic solution to obtain a dispersion having a concentration of 5 mass %.
Dispersion conditions: The dried measurement sample (10 mg) of the toner particles was added to 5 mL of the dispersion and dispersed by an ultrasonic disperser for 1 minute, and then 25 mL of the electrolytic solution was added thereto, followed by further dispersion by an ultrasonic disperser for 1 minute to prepare a sample dispersion.
Measurement conditions: The sample dispersion was added to 100 mL of the electrolytic solution to adjust the concentration at which the particle diameter of 30000 particles could be measured in 20 seconds. Then, 30000 particles were measured, and the volume median particle diameter D₅₀ and the volume average particle diameter Dv were determined from the particle diameter distribution thereof.

The CV value (%) was calculated according to the following equation.

CV value (%)=(standard deviation of particle diameter distribution/volume average particle diameter Dv)×100

### [Circularity of Toner Particles]

Measurement apparatus: flow-type particle image analyzer “FPIA-3000” (available from Sysmex Corporation)
Preparation of dispersion: The dispersion of the toner particles was diluted with deionized water so as to attain a solid content concentration of from 0.001 to 0.05 mass %.
Measurement mode: HPF measurement mode

### [Production of Resin]

### [Production of Amorphous Polyester-based Resin A]

### Production Example A1 (Production of Resin A-1)

A 10-L volume four-necked flask equipped with a nitrogen-introducing tube, a dehydrating tube, a stirrer, and a thermo-couple was nitrogen-purged, charged with 4367 g of a propylene oxide (2.2) adduct of bisphenol A, 1098 g terephthalic acid, 32 g of tin (II) di(2-ethylhexanoate), and 3.2 g of gallic acid (3,4,5-trihydroxybenzoic acid), subjected to a temperature increase to 235 °C while stirring the reaction system under a nitrogen atmosphere, held at 235 °C for 5 hours, then depressurized, and held at 8 kPa for 1 hour. Thereafter, the reaction system was returned to the atmospheric pressure, cooled to 160 °C, and added dropwise with a mixture of 1070 g of styrene, 267 g of stearyl methacrylate, 144 g of acrylic acid, and 160 g of dibutyl peroxide over 3 hours while holding the temperature at 160 °C. Thereafter, the reaction system was held at 160 °C for 30 minutes, and then subjected to a temperature increase to 200 °C. The flask was further depressurized, and held at 8 kPa for 1 hour. Thereafter, the reaction system was returned to the atmospheric pressure, cooled to 190 °C, 174 g of fumaric acid, 378 g of sebacic acid, 240 g of trimellitic anhydride and 3.2 g of 4-tert-butylcatechol were added thereto, and the reaction system was subjected to a temperature increase to 210 °C at a rate of 10 °C/hr. The reaction was then carried out at 4 kPa until the softening point shown in Table 1, and a resin A-1 was obtained. The physical property values are shown in Table 1.

### Production Example A2 (Production of Resin A-2)

A resin A-2 was obtained in the same manner as in Production Example A1, except that the amounts of the raw material monomers for the polyester resin segment and the like were changed as shown in Table 1. The physical property values are shown in Table 1.

### Production Example A3 (Production of Resin A-3)

A 10-L volume four-necked flask was charged with the raw material monomers for the polyester resin other than isophthalic acid, the esterification catalyst, and the esterification co-catalyst shown in Table 1, the 10-L volume four-necked flask being equipped with a nitrogen-introducing tube, a dehydrating tube equipped with a fractionating tube through which hot water at 98 °C was passed, a stirrer, and a thermo-couple. Under a nitrogen atmosphere, the reaction system was held at 180 °C for 1 hour, then subjected to a temperature increase from 180 °C to 230 °C at a rate of 10 °C/h, and then held at 230 °C for 5 hours to perform polycondensation. After cooling to 180 °C, isophthalic acid was charged into the reaction system. The reaction system was subjected to a temperature increase from 180 °C to 230 °C at a rate of 10 °C/h, the reaction was carried out at 230 °C for 1 hour, and the reaction was carried out at 230 °C and 10 kPa until the softening point shown in Table 1, thereby obtaining a resin A-3. The physical property values are shown in Table 1.

### [Production of Amorphous Polyester-Based Resin B]

### Production Example B1 (Production of Resin B-1)

A 20-L volume stainless steel vessel equipped with a nitrogen-introducing tube, a dehydrating tube, a stirrer, and a thermo-couple was charged with the raw material monomers for the polyester resin except trimellitic anhydride shown in Table 1. The mixture was reacted at 230 °C for 8 hours under a nitrogen atmosphere, and then reacted for 4 hours under a reduced pressure of from 1.3 kPa to 2.0 kPa. After addition of trimellitic anhydride, the reaction was carried out at 180 °C up to the softening point shown in Table 1 to obtain a resin B-1. The physical property values are shown in Table 1.

### Production Example B2 (Production of Resin B-2)

A 10-L volume four-necked flask equipped with a nitrogen-introducing tube, a dehydrating tube equipped with a fractionating tube through which hot water at 98 °C was passed, a stirrer, and a thermo-couple was charged with the raw material monomers for the polyester resin other than fumaric acid, the esterification catalyst, and the esterification co-catalyst shown in Table 1. Under a nitrogen atmosphere, the reaction system was held at 180 °C for 1 hour, then subjected to a temperature increase from 180 °C to 230 °C at a rate of 10 °C/h, and then held at 230 °C for 5 hours to perform polycondensation. After cooling to 180 °C, fumaric acid and 5 g of a radical polymerization inhibitor were charged into the reaction system. The reaction system was subjected to a temperature increase from 180 °C to 210 °C at a rate of 10 °C/h, the reaction was carried out at 210 °C for 1 hour, and the reaction was carried out at 210 °C and 10 kPa until the softening point shown in Table 1, thereby obtaining a resin B-2. The physical property values are shown in Table 1.

### [Production of Composite Resin D]

### Production Example D1 (Production of Resin D-1)

A 10-L volume four-necked flask equipped with a nitrogen-introducing tube, a dehydrating tube, a stirrer, and a thermo-couple was nitrogen-purged, charged with 3450 g of a propylene oxide (2.2) adduct of bisphenol A, 655 g terephthalic acid, 24 g of tin (II) di(2-ethylhexanoate), and 2.4 g of gallic acid (3,4,5-trihydroxybenzoic acid), subjected to a temperature increase to 235 °C while stirring the reaction system under a nitrogen atmosphere, held at 235 °C for 5 hours, then depressurized, and held at 8 kPa for 1 hour. Thereafter, the reaction system was returned to the atmospheric pressure, cooled to 160 °C, and added dropwise with a mixture of 2133 g of styrene, 533 g of stearyl methacrylate, 114 g of acrylic acid, and 320 g of dibutyl peroxide over 3 hours while holding the temperature at 160 °C. Thereafter, the reaction system was held at 160 °C for 30 minutes, and then subjected to a temperature increase to 200 °C. The flask was further depressurized, and held at 8 kPa for 1 hour. Thereafter, the reaction system was returned to the atmospheric pressure, cooled to 190 °C, supplemented with 582 g of succinic acid, and subjected to a temperature increase to 210 °C at a rate of 10 °C/hr. The reaction was then carried out at 4 kPa until the softening point shown in Table 1, and a resin D-1 was obtained. The physical property values are shown in Table 1.

TABLE 1

| | | | Production | | Production | | Production | |
|---|---|---|---|---|---|---|---|---|
| | | | Example A1 | | Example A2 | | Example A3 | |
| Resin | Type of resin | | Composite | | Composite | | Amorphous | |
| | | | resin | | resin | | polyester resin | |
| | Resin number | | A-1 | | A-2 | | A-3 | |
| Raw material monomer (P) for | | | g | Parts by | g | Parts by | g | Parts by |
| polyester resin or polyester resin | | | | mole*² | | mole*² | | mole*² |
| segment | Alcohol | BPA-PO*¹ | 4367 | 100 | 3253 | 100 | — | — |
| | component | BPA-EO*¹ | — | — | — | — | — | — |
| | | Neopentyl glycol | — | — | — | — | 3082 | 100 |
| | | 1,2-Propanediol | — | — | — | — | — | — |
| | Carboxylic | Terephthalic acid | 1098 | 53 | 1003 | 65 | 3106 | 63 |
| | acid | Isophthalic acid | — | — | — | — | 1812 | 37 |
| | component | Fumaric acid | 174 | 12 | 129 | 12 | — | — |
| | | Sebacic acid | 378 | 15 | 94 | 5 | — | — |
| | | Succinic acid | — | — | — | — | — | — |
| | | Dodecenylsuccinic | — | — | — | — | — | — |
| | | anhydride | | | | | | |
| | | Adipic acid | — | — | — | — | — | — |
| | | Trimellitic | 240 | 10 | 214 | 12 | — | — |
| | | anhydride | | | | | | |
| Bireactive monomer | Acrylic acid | | 144 | 16 | 107 | 16 | — | — |
| Raw material monomer (V) for | | | g | Mass %*³ | g | Mass %*³ | g | Mass %*³ |
| addition polymerization resin | Styrene | | 1070 | 80 | 2139 | 80 | — | — |
| segment | Stearyl methacrylate | | 267 | 20 | 535 | 20 | — | — |
| Esterification catalyst | Tin (II) di(2-ethylhexanoate) (g) | | 32 | | 24 | | 40 | |
| Esterification co-catalyst | 3,4,5-Trihydroxybenzoic acid (g) | | 3.2 | | 2.4 | | 4 | |
| Radical polymerization initiator | Dibutyl peroxide (g) | | 160 | | 321 | | — | |
| Radical polymerization inhibitor | 4-Tert-butylcatechol (g) | | 3.2 | | 2.4 | | — | |
| Addition polymerization resin segment amount (mass %)*⁴ | | | 20 | | 40 | | — | |
| Physical properties | Softening point (°C) | | 116 | | 121 | | 109 | |
| | Glass transition temperature (°C) | | 55 | | 47 | | 63 | |
| | Crystallinity index | | 1.8 | | 1.8 | | 1.7 | |
| | Acid value (mgKOH/g) | | 21 | | 23 | | 21 | |
| | SP value (cal/cm³)^{1/2} | | 10.60 | | 10.48 | | 11.33 | |
| | | | Production | | Production | | Production | |
| | | | Example B1 | | Example B2 | | Example D1 | |
| Resin | Type of resin | | Amorphous | | Amorphous | | Composite | |
| | | | polyester resin | | polyester resin | | resin | |
| | Resin number | | B-1 | | B-2 | | D-1 | |
| Raw material monomer (P) for | | | g | Parts by | g | Parts by | g | Parts by |
| polyester resin or polyester resin | | | | mole*² | | mole*² | | mole*² |
| segment | Alcohol | BPA-PO*¹ | — | — | — | — | 3450 | 100 |
| | component | BPA-EO*¹ | 5224 | 100 | — | — | — | — |
| | | Neopentyl glycol | — | — | — | — | — | — |
| | | 1,2-Propanediol | — | — | 2658 | 100 | — | — |
| | Carboxylic | Terephthalic acid | 2134 | 80 | 4936 | 85 | 655 | 40 |
| | acid | Isophthalic acid | — | — | — | — | — | — |
| | component | Fumaric acid | — | — | 406 | 10 | — | — |
| | | Sebacic acid | — | — | — | — | — | — |
| | | Succinic acid | — | — | — | — | 582 | 50 |
| | | Dodecenylsuccinic | 215 | 5 | — | — | — | — |
| | | anhydride | | | | | | |
| | | Adipic acid | 117 | 5 | — | — | — | — |
| | | Trimellitic | 309 | 10 | — | — | — | — |
| | | anhydride | | | | | | |
| Bireactive monomer | Acrylic acid | | — | — | — | — | 114 | 16 |
| Raw material monomer (V) for | | | g | Mass %*³ | g | Mass %*³ | g | Mass %*³ |

| | | | | | | | |
|---|---|---|---|---|---|---|---|
| addition polymerization resin | Styrene | — | — | — | — | 2133 | 80 |
| segment | Stearyl methacrylate | — | — | — | — | 533 | 20 |

| Esterification catalyst | Tin (II) di(2-ethylhexanoate) (g) | 40 | 40 | 24 |
|---|---|---|---|---|
| Esterification co-catalyst | 3,4,5-Trihydroxybenzoic acid (g) | 4 | 4 | 2.4 |
| Radical polymerization initiator | Dibutyl peroxide (g) | — | — | 320 |
| Radical polymerization inhibitor | 4-Tert-butylcatechol (g) | — | 4 | — |
| Addition polymerization resin segment amount (mass %)*⁴ | | — | — | 40 |
| Physical properties | Softening point (°C) | 115 | 112 | 91 |
| | Glass transition temperature (°C) | 63 | 68 | 42 |
| | Crystallinity index | 1.7 | 1.7 | 1.8 |
| | Acid value (mgKOH/g) | 21 | 24 | 24 |
| | SP value (cal/cm³)^{1/2} | 11.31 | 11.93 | 10.40 |

(Notes regarding Table 1)
*¹BPA-PO refers to a polyoxypropylene (2.2) adduct of bisphenol A. BPA-EO refers to a polyoxyethylene (2.2) adduct of bisphenol A.
*²This refers to parts by mole of each monomer constituting the raw material monomer (P) and the bireactive monomer when the alcohol component of the raw material monomer (P) is 100 parts by mole.
*³This refers to a content (mass %) of each monomer constituting the raw material monomer (V) in the total amount of the raw material monomers (V).
*⁴An amount (mass %) relative to 100 parts by mass of the total amount of the polyester resin segment, the addition polymerization resin segment, and the structural unit derived from the bireactive monomer

The amount of the polyester resin segment was defined as theoretical yield excluding the amount of reaction water, and the amount of the bireactive monomer was also defined as theoretical yield excluding the amount of reaction water. Further, the amount of the addition polymerization resin segment was calculated under the assumption that the amount of the radical polymerization initiator was included therein.

### [Production of Crystalline Polyester Resin C]

### Production Example C1 (Production of Resin C-1)

A 10-L volume four-necked flask equipped with a nitrogen-introducing tube, a dehydrating tube, a stirrer and a thermo-couple was nitrogen-purged, charged with the raw material monomers for the polyester resin shown in Table 2, subjected to a temperature increase to 135 °C while stirring the reaction system, held at 135 °C for 3 hours, and then subjected to a temperature increase from 135 °C to 200 °C over 10 hours. Thereafter, 10 g of tin (II) di(2-ethylhexanoate) was added to the reaction system, and the reaction system was further held at 200 °C for 1 hour. Then, the flask was depressurized, and held for 1 hour under a reduced pressure of 8 kPa, and a resin C-1 as a crystalline polyester resin was obtained. The physical property values are shown in Table 2.

### Production Examples C2, C3, C′4, C5, C′6, and C′7 (Production of Resins C-2, C-3, C′-4, C-5, C′-6, and C′-7)

Resins C-2, C-3, C′-4, C-5, C′-6, and C′-7 were obtained in the same manner as in Production Example C1 except that the raw material monomers for the polyester resin were changed as shown in Table 2. The physical property values are shown in Table 2.

TABLE 2

| Production Examples | | | C1 | | C2 | | C3 | | C′4 | |
|---|---|---|---|---|---|---|---|---|---|---|
| Crystalline polyester resin | | | C-1 | | C-2 | | C-3 | | C′-4 | |
| Raw material | | | Parts | Charged | Parts | Charged | Parts | Charged | Parts | Charged |
| monomer of | | | by | amount | by | amount | by | amount | by | amount |
| polyester | | | mole *1 | (g) | mole *1 | (g) | mole *1 | (g) | mole *1 | (g) |
| resin | Alcohol | Ethylene glycol | 100 | 1042 | 100 | 961 | 100 | 1159 | — | — |
| | component | 1,4-Butanediol | — | — | — | — | — | — | 100 | 1383 |
| | Carboxylic | Succinic acid | — | — | — | — | — | — | — | — |
| | acid | Sebacic acid | — | — | — | — | 90 | 3339 | — | — |
| | component | 1,12- | 90 | 3480 | — | — | — | — | 90 | 3181 |
| | | Dodecanedioic | | | | | | | | |
| | | acid | | | | | | | | |
| | | 1,14- | — | — | 90 | 3599 | — | — | — | — |
| | | Tetradecanedioic | | | | | | | | |
| | | acid | | | | | | | | |
| | | Stearic acid | 10 | 478 | 10 | 440 | 10 | 522 | 10 | 436 |
| Esterification | Tin (II) di(2-ethylhexanoate) (g) | | 10 | | 10 | | 10 | | 10 | |
| catalyst | | | | | | | | | | |

| Physical properties | Ester group | 7.6 | 6.9 | 8.4 | 6.8 |
|---|---|---|---|---|---|
| | concentration | | | | |
| | (mmol/g) | | | | |
| | Softening point (°C) | 84.2 | 89.8 | 77.8 | 80.1 |
| | Melting point (°C) | 83.6 | 88.4 | 75.1 | 79.5 |
| | Crystallinity index | 1.01 | 1.02 | 1.04 | 1.01 |
| | Acid value | 6.3 | 6.8 | 7.1 | 7.2 |
| | (mgKOH/g) | | | | |

| | | | | |
|---|---|---|---|---|
| SP value (cal/cm³)^{1/2} | 9.87 | 9.73 | 10.04 | 9.72 |

| Production Examples | | | C5 | | C′6 | | C′7 | |
|---|---|---|---|---|---|---|---|---|
| Crystalline polyester resin | | | C-5 | | C′-6 | | C′-7 | |
| Raw material | | | Parts | Charged | Parts | Charged | Parts | Charged |
| monomer of | | | by | amount | by | amount | by | amount |
| polyester | | | mole *1 | (g) | mole *1 | (g) | mole *1 | (g) |
| resin | Alcohol | Ethylene glycol | 100 | 1009 | 100 | 1577 | — | — |
| | component | 1,4-Butanediol | — | — | — | — | 100 | 1284 |
| | Carboxylic | Succinic acid | — | — | 90 | 2701 | — | — |
| | acid | Sebacic acid | — | — | — | — | — | — |
| | component | 1,12- | — | — | — | — | — | — |
| | | Dodecanedioic | | | | | | |
| | | acid | | | | | | |
| | | 1,14- | 95 | 3991 | — | — | 90 | 3311 |
| | | Tetradecanedioic | | | | | | |
| | | acid | | | | | | |
| | | Stearic acid | — | — | 10 | 722 | 10 | 405 |
| Esterification | Tin (II) di(2-ethylhexanoate) (g) | | 10 | | 10 | | 10 | |
| catalyst | | | | | | | | |

| | | | | |
|---|---|---|---|---|
| Physical properties | Ester group | 7.0 | 12.0 | 6.3 |

| concentration | | | |
|---|---|---|---|
| (mmol/g) | | | |
| Softening point (°C) | 90.1 | 102.4 | 85.5 |
| Melting point (°C) | 88.5 | 100.1 | 84.3 |
| Crystallinity index | 1.02 | 1.02 | 1.03 |
| Acid value | 6.9 | 6.9 | 7.3 |
| (mgKOH/g) | | | |

| | | | |
|---|---|---|---|
| SP value (cal/cm³)^{1/2} | 9.85 | 10.99 | 9.61 |

*1 This refers to parts by mole of each monomer constituting the raw material monomer when the alcohol component of the raw material monomer is 100 parts by mole.

### [Production of Amorphous Resin Particle Dispersion]

### Production Example X1 (Production of Amorphous Resin Particle Dispersion X-1)

In a 2-L volume container equipped with a stirrer, a reflux condenser, a dropping funnel, a thermometer, and a nitrogen-introducing tube, 100 g of the resin A-1 shown in Table 3 and 100 g of methyl ethyl ketone were charged, and dissolved at 73 °C over 2 hours. A 5 mass % aqueous sodium hydroxide solution was added to the obtained solution so that the degree of neutralization was 60 mol % with respect to the acid value of the resin, and the mixture was stirred for 30 minutes.

Next, while holding the mixture at 73 °C and stirring it at 200 r/min, 100 g of deionized water was added over 50 minutes to perform phase inversion emulsification. While the obtained solution was held at 73 °C, methyl ethyl ketone was distilled off under reduced pressure to obtain a dispersion. Thereafter, the dispersion was cooled to 30 °C while stirring was continued, and then deionized water was added so that the solid content concentration was 20 mass %, thereby obtaining a resin particle dispersion X-1. The physical property values are shown in Table 3.

### Production Examples X2 and X3 (Production of Amorphous Resin Particle Dispersions X-2 and X-3)

Resin particle dispersions X-2 and X-3 were obtained in the same manner as in Production Example X1 except that the resin was changed as shown in Table 3. The physical property values are shown in Table 3.

### Production Examples Y1 to Y3, Y′4, Y5, Y′6, and Y′7 (Production of Crystalline Resin Particle Dispersions Y-1 to Y-3, Y′-4, Y-5, Y′-6, and Y′-7)

Resin Particle dispersions Y-1 to Y-3, Y′-4, Y-5, Y′-6, and Y′-7 were obtained in the same manner as in Production Example X1 except that the resin was changed as shown in Table 3. The physical property values are shown in Table 3.

### Production Example Z1 (Production of Resin Particle Dispersion Z-1)

In a 3-L volume container equipped with a stirrer, a reflux condenser, a dropping funnel, a thermometer, and a nitrogen-introducing tube, 100 g of the resin B-1 and 100 g of methyl ethyl ketone were charged, and dissolved at 73 °C over 2 hours. To the obtained solution, a 5 mass % aqueous sodium hydroxide solution was added so that the degree of neutralization was 60 mol % with respect to the acid value of the resin B-1, and the mixture was stirred for 30 minutes.

Next, while holding the mixture at 73 °C and stirring it at 200 r/min (peripheral speed: 63 m/min), 200 g of deionized water was added over 50 minutes to perform phase inversion emulsification. While the obtained solution was held at 73 °C, methyl ethyl ketone was distilled off under reduced pressure to obtain a dispersion. Thereafter, the dispersion was cooled to 30 °C while stirring was continued, and then deionized water was added so that the solid content concentration was 20 mass %, thereby obtaining a resin particle dispersion Z-1. The physical property values are shown in Table 3.

### Production Example Z2 (Production of Resin Particle Dispersion Z-2)

A resin particle dispersion Z-2 was obtained in the same manner as in Production Example Z1 except that the resin B-1 was changed to the resin B-2. The physical property values are shown in Table 3.

### Production Example S1 (Production of Resin Particle Dispersion S-1)

A resin particle dispersion S-1 was obtained in the same manner as in Production Example Z1 except that the resin B-1 was changed to the resin D-1. The physical property values are shown in Table 3.

TABLE 3
Table 3

| | Produc- | Produc- | Produc- | Produc- | Produc- | Produc- | Produc- | Produc- | Produc- | Produc- | Produc- | Produc- | Produc- |
|---|---|---|---|---|---|---|---|---|---|---|---|---|---|
| | tion | tion | tion | tion | tion | tion | tion | tion | tion | tion | tion | tion | tion |
| | Exam- | Exam- | Exam | Exam | Exam | Exam | Exam | Exam | Exam | Exam | Exam | Exam | Exam |
| | ple X1 | ple X2 | ple X3 | ple Y1 | ple Y2 | ple Y3 | ple Y′4 | ple Y5 | ple Y′6 | ple Y′7 | ple Z1 | ple Z2 | ple S1 |
| Resin | X-1 | X-2 | X-3 | Y-1 | Y-2 | Y-3 | Y′-4 | Y-5 | Y′-6 | Y′-7 | Z-1 | Z-2 | S-1 |
| particle | | | | | | | | | | | | | |
| dispersion | | | | | | | | | | | | | |
| Resin | A-1 | A-2 | A-3 | C-1 | C-2 | C-3 | C′-4 | C-5 | C′-6 | C′-7 | B-1 | B-2 | D-1 |
| Volume | 0.13 | 0.15 | 0.12 | 0.12 | 0.11 | 0.12 | 0.14 | 0.11 | 0.13 | 0.12 | 0.08 | 0.09 | 0.11 |
| median | | | | | | | | | | | | | |
| particle | | | | | | | | | | | | | |
| diameter | | | | | | | | | | | | | |
| D₅₀ (mm) | | | | | | | | | | | | | |
| CV value | 27 | 24 | 25 | 25 | 29 | 25 | 26 | 24 | 29 | 28 | 25 | 23 | 27 |
| (%) | | | | | | | | | | | | | |

### [Production of Releasing Agent Particle Dispersion]

### Production Example W1 (Production of Releasing Agent Particle Dispersion W-1)

A 1-L volume beaker was filled with 120 g of deionized water, 86 g of the resin particle dispersion S-1, and 40 g of paraffin wax “HNP-9” (available from Nippon Seiro Co., Ltd., melting point: 75 °C). The mixture was molten while the temperature was held at from 90 to 95 °C, and stirred to obtain a molten mixture.

The obtained molten mixture was subjected to a dispersion treatment for 20 minutes using an ultrasonic homogenizer “US-600T” (available from NIHONSEIKI KAISHA LTD.) while the temperature was further held at from 90 to 95 °C, and then cooled to room temperature (20 °C). Deionized water was added to the obtained dispersion to adjust the solid content concentration to 20 mass %, thereby obtaining a releasing agent particle dispersion W-1. The releasing agent particles in the releasing agent particle dispersion W-1 had a volume median particle diameter D₅₀ of 0.47 μm and a CV value of 27%.

### Production Example W2 (Production of Releasing Agent Particle Dispersion W-2)

A releasing agent particle dispersion W-2 was obtained in the same manner as in Production Example W1, except that the type of releasing agent was changed to Fischer-Tropsch wax “FNP-0090” (available from Nippon Seiro Co., Ltd., melting point: 90 °C). The releasing agent particles in the releasing agent particle dispersion W-2 had a volume median particle diameter D₅₀ of 0.45 μm and a CV value of 28%.

[Production of Colorant Particle Dispersion]

### Production Example E1 (Production of Colorant Particle Dispersion E-1)

In a 1-L volume beaker, 75 g of a yellow pigment “Paliotol Yellow D1155” (available from BASF Colors & Effects Japan Ltd., C. I. Pigment Yellow 185), 25 g of a polyoxyethylene (13) distyrenated phenyl ether “EMULGEN A-60” (available from Kao Corporation, nonionic surfactant), and 300 g of deionized water were mixed. The mixture was dispersed for 1 hour at room temperature (20 °C) and a rotational speed of a stirring blade of 8000 rpm, using a homomixer “T. K. AGI HOMOMIXER 2M-03” (available from PRIMIX Corporation), then subjected to a 15 pass treatment at a pressure of 150 MPa using “Microfluidizer M-110EH” (available from Microfluidics Corporation), and then passed through a 200 mesh filter. Deionized water was added so that the solid content concentration was 20 mass %, thereby obtaining a colorant particle dispersion E-1. The physical property values are shown in Table 4.

### Production Examples E2, E′3, and E′4 (Production of Colorant Particle Dispersions E-2, E′-3, and E′-4)

Colorant particle dispersions E-2, E′-3, and E′-4 were obtained in the same manner as in Production Example E1 except that the yellow pigment was changed as shown in Table 4. The physical property values are shown in Table 4.

TABLE 4

| Production Examples | E1 | E2 | E′3 | E′4 |
|---|---|---|---|---|
| Colorant particle dispersion | E-1 | E-2 | E′-3 | E′-4 |
| Colorant | PY185 | PY180 | PY155 | PY74 |
| Molecular weight of colorant (pigment) | 337 | 733 | 717 | 386 |
| Number of NH groups in one molecule of pigment | 4 | 6 | 2 | 1 |
| NH group amount (mmol/g) | 11.9 | 8.2 | 2.8 | 2.6 |
| (Value obtained by dividing number of NH groups in one | | | | |
| molecule of pigment by molecular weight of pigment) | | | | |
| Volume median particle diameter D₅₀ (μm) | 0.15 | 0.14 | 0.14 | 0.13 |
| CV value (%) | 28 | 26 | 29 | 23 |

PY185: yellow pigment “Paliotol Yellow D1155”
(C. I. Pigment Yellow 185, available from BASF Colors & Effects Japan Ltd.)
PY180: yellow pigment “Toner Yellow HG”
(C. I. Pigment Yellow 180, available from Clariant Chemicals Ltd.)
PY155: yellow pigment “Toner Yellow 3GP-CT”
(C. I. Pigment Yellow 155, available from Clariant Chemicals Ltd.)
PY74: yellow pigment “Fast Yellow 7414”
(C. I. Pigment Yellow 74, available from Sanyo Color Works, LTD.)

### [Production of Toner]

### Example 1 (Production of Toner 1)

In a 3-L volume four-necked flask equipped with a dehydrating tube, a stirrer, and a thermo-couple, 350 g of the amorphous resin particle dispersion X-1, 150 g of the crystalline resin particle dispersion Y-1, 49 g of the releasing agent particle dispersion W-1, 49 g of the releasing agent particle dispersion W-2, and 63 g of the colorant particle dispersion E-1 were added, and mixed at a temperature of 25 °C. Next, while the mixture was stirred, a solution prepared by adding a 4.8 mass % aqueous potassium hydroxide solution to an aqueous solution prepared by dissolving 40 g of ammonium sulfate in 570 g of deionized water to adjust the pH to 8.2 was added dropwise at 25 °C over 10 minutes. Then, the mixture was subjected to a temperature increase to 58 °C over 2 hours, and held at 58 °C until the volume median particle diameter D₅₀ of the aggregated particles reached 6.5 μm, thereby obtaining a dispersion of aggregated particles 1. The obtained dispersion of the aggregated particles 1 was cooled to 55 °C, and 48 g of the resin particle dispersion Z-1 was added over 90 minutes while the temperature was held at 55 °C, thereby obtaining a dispersion of aggregated particles 2 in which the resin particles were aggregated with the aggregated particles 1.

The obtained dispersion of the aggregated particles 2 was supplemented with 50 g of a 20 mass % aqueous solution of “Demol MS”, as a sodium salt of a naphthalenesulfonic acid formalin condensate (available from Kao Corporation), and 1500 g of deionized water. Thereafter, the solution was subjected to a temperature increase to 75 °C over 1 hour and held at 75 °C until the circularity reached 0.970, thereby obtaining a dispersion of coalesced particles in which the aggregated particles 2 were coalesced.

The obtained dispersion of the coalesced particles was cooled to 30 °C and subjected to suction filtration to separate a solid content, followed by washing with deionized water at 25 °C and suction filtration at 25 °C for 2 hours. Thereafter, vacuum drying was performed at 33 °C for 24 hours using a vacuum constant temperature dryer “DRV622DA” (available from Toyo Roshi Kaisha, Ltd.) to obtain toner particles having a core-shell structure. The physical property values of toner particles 1 are shown in Table 5.

In a Henschel mixer, 100 parts by mass of the toner particles 1, 2.5 parts by mass of hydrophobic silica “RY 50” (available from Nippon Aerosil Co., Ltd., number average particle diameter: 0.04 μm), and 1.0 parts by mass of hydrophobic silica “CAB-O-SIL (trade name) TS720” (available from Cabot Japan K. K., number average particle diameter: 0.012 μm) were charged, stirred, and passed through a 150 mesh sieve to obtain a toner 1.

### [Evaluation of Toner]

The obtained toner 1 was evaluated as follows.

### [Evaluation of Low-Temperature Fusing Property]

On a polypropylene film label “Forest PP Clear FTC 50” (available from UPM-Kymmene Japan K. K.) cut into an A4 size, a solid image in which the amount of the toner attached onto the film label was from 0.43 to 0.45 mg/cm² was output without being fused at a length of 50 mm by using a commercially available printer “Microline (trade name) 5400” (available from OKI Electric Industry Co., Ltd.) while a margin of 5 mm was left from the upper end of the A4-size film label. Next, the same printer in which a fusing device was modified to be variable in temperature was prepared, and a printed matter was subjected to a fusing test at each temperature while the temperature of the fusing device was sequentially increased from 70 °C to 120 °C in increments of 5 °C. A cellophane pressure-sensitive adhesive tape “UNICEF Cellophane” (available from MITSUBISHI PENCIL COMPANY, LIMITED, wide: 18 mm, JIS Z1522:2009) was pasted to an image portion of the obtained label printed matter, and the tape was peeled off. The optical reflection densities before the tape was pasted and after the tape was peeled off were measured using a reflection densitometer “RD-915” (available from GretagMacbeth LLC), and the temperature of a fusing roll at which the ratio between the optical reflection density before the tape was pasted and the optical reflection density after the tape was peeled off (100× optical reflection density after peeling/optical reflection density before pasting) first exceeded 90% was defined as minimum fusing temperature. The lower the minimum fusing temperature is, the better the low-temperature fusing property is.

### Evaluation of Hardness of Printed Coating Film (Fastness of Printed Coating Film)

On a polypropylene film label “Forest PP Clear FTC 50” (available from UPM-Kymmene Japan K. K.) cut into an A4 size, a solid image in which the amount of the toner attached onto the film label was from 0.43 to 0.45 mg/cm² was output without being fused at a length of 50 mm by using a commercially available printer “Microline (trade name) 5400” (available from OKI Electric Industry Co., Ltd.) while a margin of 5 mm was left from the upper end of the A4-size film label. Next, the same printer in which the fusing device was modified to be variable in temperature was prepared, the temperature of the fusing device was set to 100 °C, and the toner 1 was fused at a speed of 3 seconds per sheet in the longitudinal direction of A4 to form a printed coating film, thereby obtaining a label printed matter (corresponding to 20 sheets per minute in the longitudinal direction of A4).

With respect to the obtained label printed matter, the pencil hardness of the printed coating film was measured using a pencil-scratch coating film hardness tester (“D-NP (model number)”, available from Toyo Seiki Seisaku-sho, Ltd.) and pencil-scratch value test pencils (6B, 5B, 4B, 3B, 2B, B, HB, F, and H) (available from MITSUBISHI PENCIL COMPANY, LIMITED) in accordance with JIS K5600-5-4. A test of scratching the printed coating film with the pencils of the respective hardnesses was performed five times in the order of 6B, 5B, 4B, 3B, 2B, B, HB, F, and H, and the highest hardness of the pencil that caused no scar three times or more was defined as the pencil hardness of the printed coating film of the label printed matter. “H” is the most excellent in pencil hardness of the printed coating film (fastness of the printed coating film). The pencil hardness of the printed coating film obtained from the toner of the present invention is preferably B or higher. The evaluation results are shown in Table 5.

### Examples 2 to 7 and Comparative Examples 1 to 5 (Production of Toners 2 to 7 and Toners 1c to 5c)

Toner particles 2 to 7, toner particles 1c to 5c, toners 2 to 7, and toners 1c to 5c were obtained in the same manner as in Example 1, except that the amorphous resin particle dispersion, the crystalline resin particle dispersion, and the colorant particle dispersion were changed as shown in Table 5. The physical property values of the toner particles 2 to 7 and the toner particles 1c to 5c are shown in Table 5. The evaluation results of the toners 2 to 7 and the toners 1c to 5c are shown in Table 5.

### Example 8 (Production of Toner 8)

Toner particles 8 and a toner 8 were obtained in the same manner as in Example 1, except that the amount of the amorphous resin particle dispersion X-1 was changed to 400 g and that the amount of the crystalline resin particle dispersion Y-1 was changed to 100 g. The physical property values of the toner particles 8 and the evaluation results of the toner 8 are shown in Table 5.

### Example 9 (Production of Toner 9)

Toner particles 9 and a toner 9 were obtained in the same manner as in Example 1, except that the amount of the amorphous resin particle dispersion X-1 was changed to 425 g and that the amount of the crystalline resin particle dispersion Y-1 was changed to 75 g. The physical property values of the toner particles 9 and the evaluation results of the toner 9 are shown in Table 5.

### Example 10 (Production of Toner 10)

Toner particles 10 and a toner 10 were obtained in the same manner as in Example 1, except that the amorphous resin particle dispersion, the crystalline resin particle dispersion, and the colorant particle dispersion were changed as shown in Table 5, and that the resin particle dispersion Z-1 was changed to the resin particle dispersion Z-2. The physical property values of the toner particles 10 are shown in Table 5. The evaluation results of the toner 10 are shown in Table 5.

TABLE 5

| | | Example 1 | Example 2 | Example 3 | Example 4 | Example 5 | Example 6 | Example 7 | Example 8 | Example 9 |
|---|---|---|---|---|---|---|---|---|---|---|
| Toner number | | Toner 1 | Toner 2 | Toner 3 | Toner 4 | Toner 5 | Toner 6 | Toner 7 | Toner 8 | Toner 9 |
| Toner | Amorphous resin | X-1 | X-1 | X-1 | X-1 | X-1 | X-2 | X-1 | X-1 | X-1 |
| composition | particle | | | | | | | | | |
| | dispersion | | | | | | | | | |
| | Crystalline | Y-1 | Y-1 | Y-2 | Y-2 | Y-3 | Y-1 | Y-5 | Y-1 | Y-1 |
| | resin particle | | | | | | | | | |
| | dispersion | | | | | | | | | |
| | Mixing ratio | 70/30 | 70/30 | 70/30 | 70/30 | 70/30 | 70/30 | 70/30 | 80/20 | 85/15 |
| | (X/Y)*¹ | | | | | | | | | |
| | Colorant particle | E-1 | E-2 | E-1 | E-2 | E-1 | E-1 | E-1 | E-1 | E-1 |
| | dispersion | | | | | | | | | |
| Physical | Volume median | 6.4 | 6.4 | 6.5 | 6.3 | 6.5 | 6.4 | 6.5 | 6.3 | 6.5 |
| properties | particle diameter | | | | | | | | | |
| of toner | D₅₀ (μm) | | | | | | | | | |
| particle | CV value (%) | 28 | 27 | 28 | 27 | 29 | 27 | 27 | 28 | 28 |
| | Circularity | 0.970 | 0.972 | 0.972 | 0.969 | 0.971 | 0.969 | 0.969 | 0.970 | 0.973 |
| Ester group concentration | | 7.6 | 7.6 | 6.9 | 6.9 | 8.4 | 7.6 | 7.0 | 7.6 | 7.6 |
| (mmol/g) of crystalline | | | | | | | | | | |
| polyester resin C | | | | | | | | | | |
| NH group amount (mmol/g) | | 11.9 | 8.2 | 11.9 | 8.2 | 11.9 | 11.9 | 11.9 | 11.9 | 11.9 |
| of colorant | | | | | | | | | | |
| ΔSP(APES-CPES)*² | | 0.73 | 0.73 | 0.87 | 0.87 | 0.56 | 0.61 | 0.75 | 0.73 | 0.73 |
| Evaluation | Lowest fusing | 80 | 80 | 85 | 85 | 80 | 85 | 85 | 85 | 90 |
| of toner | temperature (°C) | | | | | | | | | |
| | Pencil hardness | H | H | H | F | HB | HB | B | HB | B |
| | of printed | | | | | | | | | |
| | coating film | | | | | | | | | |

| | | | Comparative | Comparative | Comparative | Comparative | Comparative |
|---|---|---|---|---|---|---|---|
| | | Example 10 | Example 1 | Example 2 | Example 3 | Example 4 | Example 5 |
| Toner number | | Toner 10 | Toner 1c | Toner 2c | Toner 3c | Toner 4c | Toner 5c |
| Toner | Amorphous resin | X-3 | X-1 | X-1 | X-1 | X-1 | X-1 |
| composition | particle | | | | | | |
| | dispersion | | | | | | |
| | Crystalline | Y-3 | Y-1 | Y-1 | Y′-6 | Y′-7 | Y′-4 |
| | resin particle | | | | | | |
| | dispersion | | | | | | |
| | Mixing ratio | 70/30 | 70/30 | 70/30 | 70/30 | 70/30 | 70/30 |
| | (X/Y)*¹ | | | | | | |
| | Colorant particle | E-1 | E′-3 | E′-4 | E-1 | E-1 | E-1 |
| | dispersion | | | | | | |
| Physical | Volume median | 6.4 | 6.3 | 6.4 | 6.5 | 6.4 | 6.5 |
| properties | particle diameter | | | | | | |
| of toner | D₅₀ (μm) | | | | | | |
| particle | CV value (%) | 27 | 29 | 29 | 28 | 27 | 28 |
| | Circularity | 0.971 | 0.970 | 0.969 | 0.971 | 0.973 | 0.971 |
| Ester group concentration | | 8.4 | 7.6 | 7.6 | 12.0 | 6.3 | 6.8 |
| (mmol/g) of crystalline | | | | | | | |
| polyester resin C | | | | | | | |
| NH group amount (mmol/g) | | 11.9 | 2.8 | 2.6 | 11.9 | 11.9 | 11.9 |
| of colorant | | | | | | | |
| ΔSP(APES-CPES)*² | | 1.29 | 0.73 | 0.73 | −0.39 | 0.99 | 0.88 |
| Evaluation | Lowest fusing | 80 | 80 | 80 | 80 | 100 | 100 |
| of toner | temperature (°C) | | | | | | |
| | Pencil hardness | HB | 3B | 3B | 6B | 6B | B |
| | of printed | | | | | | |
| | coating film | | | | | | |

*¹This refers to a ratio of the blending amount of the amorphous resin particle dispersion to the blending amount of the crystalline resin particle dispersion at the time of toner production (“ratio of the content of the amorphous polyester-based resin A to the content of the crystalline polyester resin C” in the toner (“content of amorphous polyester-based resin A”/“content of crystalline polyester resin C”)).
*²This refers to a difference between the solubility parameter of the amorphous polyester-based resin A and the solubility parameter of the crystalline polyester resin (“solubility parameter of amorphous polyester-based resin A” − “solubility parameter of crystalline polyester resin C”).

### Example 11 (Production of Toner 11)

Eighty (80) parts by mass of the amorphous polyester resin A-1, 20 parts by mass of the crystalline polyester resin C-1, 5 parts by mass of the colorant PY185 (“Paliotol Yellow D1155”, available from BASF Colors & Effects Japan Ltd., C.I. Pigment Yellow 185), 1 part by mass of a charge control agent “LR-147” (available from Carlit Co., Ltd.), and 2 parts by mass of a paraffin wax “HNP-9” (available from Nippon Seiro Co., Ltd., melting point: 75 °C) and 2 parts by mass of a paraffin wax “FNP-0090” (available from Nippon Seiro Co., Ltd., melting point: 90 °C) as releasing agents were well stirred with a Henschel mixer, and then melt-kneaded using a co-rotating twin screw extruder having a total length of a kneaded portion of 1560 mm, a screw diameter of 42 mm, and a barrel inner diameter of 43 mm. The rotational speed of the screw was 200 r/min, the preset heating temperature in the screw was 90 °C, the temperature of the kneaded product was 140 °C, the feed rate of the kneaded product was 10 kg/h, and the average residence time was about 18 seconds. The obtained kneaded product was cooled from 140 °C to 50 °C over 1.5 hours, rolled and cooled at 50 °C with a cooling roller, left to stand at 45 °C for 4 hours, pulverized with a jet mill, and classified to obtain toner particles 11. The physical property values of the toner particles 11 are shown in Table 6.

In a Henschel mixer, 100 parts by mass of the toner particles 11, 2.5 parts by mass of hydrophobic silica “RY 50” (available from Nippon Aerosil Co., Ltd., number average particle diameter: 0.04 μm), and 1.0 parts by mass of hydrophobic silica “CAB-O-SIL (trade name) TS720” (available from Cabot Japan K. K., number average particle diameter: 0.012 μm) were charged, stirred, and passed through a 150 mesh sieve to obtain a toner 11. The evaluation results of the toner 11 are shown in Table 6.

TABLE 6

| | | Example 11 |
|---|---|---|
| Toner number | | Toner 11 |
| Toner composition | Amorphous resin A-1 | 80 parts by mass |
| | Crystalline resin C-1 | 20 parts by mass |
| | Colorant (PY185) | 5 parts by mass |
| | LR-147 | 1 part by mass |
| | HNP-9 | 2 parts by mass |
| | FNP-0090 | 2 parts by mass |
| Physical properties of | Volume median particle diameter D₅₀ (μm) | 6.5 |
| toner particle | CV value (%) | 24 |
| | Circularity | 0.952 |
| Ester group concentration (mmol/g) of crystalline polyester resin C | | 7.6 |
| NH group amount (mmol/g) of colorant | | 11.9 |
| ΔSP(APES-CPES)^{*2} | | 0.73 |
| Evaluation of toner | Lowest fusing temperature (°C) | 90 |
| | Pencil hardness of printed coating film | HB |

The toners (Examples 1 to 11) produced by using the resin C, resin A, and pigment defined in the present invention are excellent in terms of low-temperature fusing property, and the printed coating films obtained from the toners have a pencil hardness of “B” or higher and are excellent in terms of fastness.

On the other hand, the toners of Comparative Examples 1 and 2 were produced using the resin C and resin A defined in the present invention, but the use of the pigments having a NH group amount of less than 6.0 mmol/g results in the pencil hardness “3B” of the printed coating films obtained from the toners and failure to obtain sufficient fastness of the printed coating films. The toner of Comparative Example 3 was produced using the resin A and the pigment defined in the present invention, but the use of the crystalline polyester resin having an ester group concentration of more than 9.0 mmol/g resulted in the pencil hardness “6B” of the printed coating film and poor fastness of the printed coating film. The toner of Comparative Example 4 was produced using the resin A and pigment defined in the present invention, but the use of the crystalline polyester resin having an ester group concentration of less than 6.5 mmol/g resulted in the pencil hardness “6B” of the printed coating film and poor fastness of the printed coating film. In addition, the toners of Comparative Examples 4 and 5 were produced using the resin A and pigment specified in the present invention, but the use of the crystalline polyester resins including no structural unit derived from an aliphatic diol component containing ethylene glycol resulted in poor low-temperature fusing property of the toner.

1. An electrostatic image development toner, comprising
a crystalline polyester resin C;
an amorphous polyester-based resin A; and
a colorant, wherein
the crystalline polyester resin C comprises a structural unit derived from an aliphatic diol component containing ethylene glycol and a structural unit derived from an aliphatic dicarboxylic acid component having 10 to 14 carbon atoms, and has an ester group concentration of 6.5 mmol/g to 9.0 mmol/g, and
the colorant is a pigment having a NH group amount of 6.0 mmol/g or more, the NH group amount being obtained by dividing a total number of —NH— and —NH₂ groups contained in one molecule of the pigment by a molecular weight of the pigment.

2. The electrostatic image development toner according to claim 1, wherein the crystalline polyester resin C further comprises a structural unit derived from a monocarboxylic acid component having 6 to 24 carbon atoms.

3. The electrostatic image development toner according to claim 1, wherein the colorant is a yellow organic pigment.

4. The electrostatic image development toner according to claim 1, wherein the colorant comprises at least one selected from an isoindoline-based pigment and a benzimidazolone pigment.

5. The electrostatic image development toner according to claim 1, wherein the colorant is at least one selected from C. I. Pigment Yellow 185 and C. I. Pigment Yellow 180.

6. The electrostatic image development toner according to claim 1, wherein a difference in solubility parameter between the amorphous polyester-based resin A and the crystalline polyester resin C is 0.50 (cal/cm³)^{1/2} to 1.00 (cal/cm³)^{1/2}.

7. The electrostatic image development toner according to claim 1, wherein a mass ratio of a content of the amorphous polyester-based resin A to a content of the crystalline polyester resin C is 60/40 to 85/15.

8. The electrostatic image development toner according to claim 1, wherein a content of the structural unit derived from the aliphatic diol component is 80 mol % to 100 mol %, in a structural unit derived from an alcohol component of the crystalline polyester resin C.

9. The electrostatic image development toner according to claim 1, wherein a content of a structural unit derived from ethylene glycol is 65 mol % to 100 mol %, in a structural unit derived from the alcohol component of the crystalline polyester resin C.

10. The electrostatic image development toner according to claim 1, wherein a content of the structural unit derived from the aliphatic dicarboxylic acid having 10 to 14 carbon atoms is 70 mol % to 100 mol %, in a structural unit derived from the carboxylic acid component of the crystalline polyester resin C.

11. The electrostatic image development toner according to claim 1, wherein a content of the colorant is 3 parts by mass to 25 parts by mass relative to 100 parts by mass of a total of the crystalline polyester resin C and the amorphous polyester-based resin A.

12. The electrostatic image development toner according to claim 1, wherein
the electrostatic image development toner comprises toner particles, and
a content of the colorant in the toner particles is 3 mass % to 25 mass % er less.

13. The electrostatic image development toner according to claim 1, which has a core-shell structure.

14. A method for producing an electrostatic image development toner, the method comprising:
aggregating resin particles comprising a crystalline polyester resin C and an amorphous polyester-based resin A in the same or different particles and a colorant in an aqueous medium; and
coalescing the resin particles and the colorant, wherein
the crystalline polyester resin C comprises a structural unit derived from an aliphatic diol component containing ethylene glycol and a structural unit derived from an aliphatic dicarboxylic acid component having 10 to 14 carbon atoms, and has an ester group concentration of 6.5 mmol/g to 9.0 mmol/g, and
the colorant is a pigment having a NH group amount of 6.0 mmol/g or more, the NH group amount being obtained by dividing a total number of —NH— and —NH₂ groups contained in one molecule of the pigment by a molecular weight of the pigment.

15. The electrostatic image development toner according to claim 1, wherein the crystalline polyester resin C has a solubility parameter of 8.70 (cal/cm³)^{1/2} to 11.00 (cal/cm³)^{1/2}.

16. The electrostatic image development toner according to claim 1, wherein the amorphous polyester-based resin A has a solubility parameter of 9.20 (cal/cm³)^{1/2} to 12.00 (cal/cm³)^{1/2}.
